(19) United States
(12) Patent Application Publication
(10) Pub. No.: US 2005/0207000 A1
(43) Pub. Date: Sep. 22, 2005

(54) Multipoint monitoring method, monitoring point apparatus, and monitoring station apparatus

(75) Inventors: Shigeo Ooaku, Kawasaki (JP); Yasuo Suzuki, Utsunomiya (JP); Akihiro Matsushita, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/042,358

(22) Filed: Jan. 26, 2005

Related U.S. Application Data
(63) Continuation of application No. PCT/JP03/01131, filed on Feb. 4, 2003.

(51) Int. Cl. H01S 3/00

(52) U.S. Cl. 359/341.41

(57) ABSTRACT

A multipoint monitoring method is provided for monitoring plural monitoring points that are connected to a monitoring station by an optical transmission line in which an optical abnormality detection signal of the wavelength component unique to a monitoring point where an abnormality is detected is multiplexed with an optical signal supplied from the optical transmission line to be output to the optical transmission line. According to such a multipoint monitoring method, a monitoring point where an abnormality is occurring may be specified by demultiplexing the optical signal supplied from the optical transmission line into wavelength components at the monitoring station and determining whether a specific wavelength component is supplied.

### CROSS REFERENCE TO RELATED APPLICATIONS

This application is a U.S. continuation application filed under 35 USC 111(a) claiming benefit under 35 USC 120 and 365(c) of PCT Application JP 2003/001131, filed on Feb. 4, 2003, the entire contents of which are hereby incorporated by reference.

### BACKGROUND OF THE INVENTION

1. Field of the Invention

The present invention relates generally to a multipoint monitoring method, a monitoring point apparatus, and a monitoring station apparatus, and particularly, to a multipoint monitoring method for reporting to a monitoring station an abnormality occurring in at least one of facilities implemented at plural monitoring points.

2. Description of the Related Art

Techniques are known for sending information to a monitoring station when an abnormality such as a breakdown or illegal trespassing occurs in at least one of plural facilities implemented at various location points (e.g., power transmission steel towers, power distribution poles, railroad facilities, road facilities, contract monitored homes and offices, pipeline facilities, and building facilities), and the monitoring station may then identify the specific location at which such an abnormality is occurring.

In a system using wireless technology, wireless transmitters are provided for the respective facilities implemented at multiple location points. According to this technique, a detector (sensor) detects an abnormality such as a breakdown and generates information pertaining to such event which information is converted into an electric wave and sent to a monitoring station. At the monitoring station, electric wave information from each facility is identified and the source (location) of the information is specified. In this technique using wireless technology, it is difficult to provide wireless transmitters at many location points due to limitations in electric wave resources and influences of noise. Also, it is difficult to emit strong electric waves from a remote location.

In a system using cable wire technology, facilities of multiple location points and a monitoring station are interconnected via a cable wire. According to this technique, information generated by a sensor is converted into an electric signal or an optical signal and transmitted to the monitoring station. At the monitoring station, a signal from each facility is identified and the source (location) of the signal is specified. This technique using cable wire technology is disadvantageous for establishing a new transmission route from an economical standpoint. Further, systems for establishing transmission routes according to this technique are often unavailable in mountainous areas and remote areas, and thereby, it is difficult for location points in such areas to implement the present technique.

For example, in a power transmission line system, steel towers supporting power transmission lines are provided at various locations. These steel towers may be susceptible to breakdown or failure as a result of thunderbolts, for example, and it is therefore important to be able to specify the steel tower sustaining such breakdown or failure.

In a specific example, in the event of a failure, an approximate location of the failure source (site) may be determined based on fluctuations in the voltage, current, and phase of the power transmission system. Then, patrolling of the approximate location may be conducted by foot or by a helicopter, for example, so that the specific steel tower sustaining the failure may be identified through visual recognition of a signal from a failure detection sensor or through visual inspection of a steel tower using binoculars, for example. However, it has conventionally been difficult to accurately assess individual steel towers to automatically detect the steel tower at which a failure is occurring. Accordingly, a technique is desired for automatically and accurately identifying a steel tower in which a failure is occurring so that patrolling as described above may not be required. However, a specific method has not yet been disclosed for transmitting information through an optical wire to signal the occurrence of a failure from the steel tower sustaining such a failure.

Japanese Patent Laid-Open Publication No. 5-292083 discloses a technique for monitoring an optical amplifier relay unit using a monitoring control signal that is multiplexed onto a main signal. However, the disclosed technique relates to a general method for transmitting various alarm signals and commands within a conventional network, and does not provide a method for directly reporting the occurrence of a failure to a monitoring station from a monitoring point such as a steel tower.

### SUMMARY OF THE INVENTION

The present invention has been conceived in response to the one or more problems of the related art, and its general object is to provide a multipoint monitoring method, a monitoring point apparatus, and a monitoring station apparatus for realizing optical transmission of information signaling the occurrence of an abnormality from a monitoring point.

The present invention, according to an aspect, provides a multipoint monitoring method for monitoring plural monitoring points that are connected to a monitoring station by an optical transmission line, the method including the steps of multiplexing onto an optical signal supplied from the optical transmission line an optical abnormality detection signal having a wavelength component that is unique to a specific monitoring point at which an abnormality is detected, and outputting the multiplexed signal to the optical transmission line.

In a method according to an aspect of the present invention, at the monitoring station, the multiplexed optical signal supplied from the optical transmission line may be demultiplexed into wavelength components so as to determine the monitoring point at which the abnormality is occurring based on whether a corresponding wavelength component is supplied.

According to another aspect of the present invention, a monitoring point apparatus is provided for realizing the multipoint monitoring method according to the present invention.

According to another aspect of the present invention, a monitoring station apparatus is provided for realizing the multipoint monitoring method according to the present invention.

### BRIEF DESCRIPTION OF THE DRAWINGS

FIG. 1 is a diagram showing a configuration of a multipoint monitoring system according to a first embodiment of the present invention;

FIG. 2 is a block diagram showing a configuration of an optical transmission apparatus that is used in the multipoint monitoring system according to the first embodiment;

FIG. 3 is a block diagram showing a configuration of a monitoring station used in the multipoint monitoring system according to the first embodiment;

FIG. 4 is a diagram illustrating a signal flow of optical failure detection signals according to the first embodiment;

FIG. 5 is a diagram illustrating connections of arrayed waveguide gratings according to the first embodiment;

FIG. 6 is a diagram illustrating a signal flow of optical failure detection signals according to a second embodiment of the present invention;

FIG. 7 is a diagram illustrating connections of arrayed waveguide gratings according to the second embodiment;

FIG. 8 is a diagram showing a configuration of a multipoint monitoring system according to a third embodiment of the present invention;

FIG. 9 is a block diagram showing a configuration of an optical transmission apparatus that is used in the multipoint monitoring system according to the third embodiment;

FIG. 10 is a diagram illustrating a signal flow of optical failure detection signals, control signals, and moving image signals according to the third embodiment;

FIG. 11 is a diagram illustrating connections of arrayed waveguide gratings according to the third embodiment;

FIG. 12 is a flowchart illustrating operational processes pertaining to moving image transmission in the multipoint monitoring system according to the third embodiment;

FIG. 13 is a diagram illustrating a signal flow of optical failure detection signals, control signals, and moving image signals according to a fourth embodiment of the present invention;

FIG. 14 is a diagram illustrating connections of arrayed waveguide gratings according to the fourth embodiment;

FIG. 15 is a diagram showing a configuration of a multipoint monitoring system according to a fifth embodiment of the present invention;

FIG. 16 is a diagram illustrating a signal flow of optical failure detection signals, control signals, and carrier wave signals according to the fifth embodiment;

FIG. 17 is a diagram illustrating connections of arrayed waveguide gratings according to the fifth embodiment;

FIG. 18 is a diagram illustrating a signal flow of optical failure detection signals, control signals, and moving image signals according to a sixth embodiment of the present invention; and

FIG. 19 is a diagram illustrating connections of arrayed waveguide gratings according to the sixth embodiment.

### DESCRIPTION OF THE PREFERRED EMBODIMENTS

In the following, preferred embodiments of the present invention are described with reference to the accompanying drawings.

It is noted that first through sixth embodiments illustrated below correspond to exemplary applications of the present invention to a power transmission system. In these examples, an optical fiber that is implemented in or attached to a OPGW (optical fiber overhead ground wire) is used as a transmission line for reporting to a monitoring station cases of abnormalities occurring at monitoring points, such optical fiber being referred to as OPGW optical fiber hereinafter.

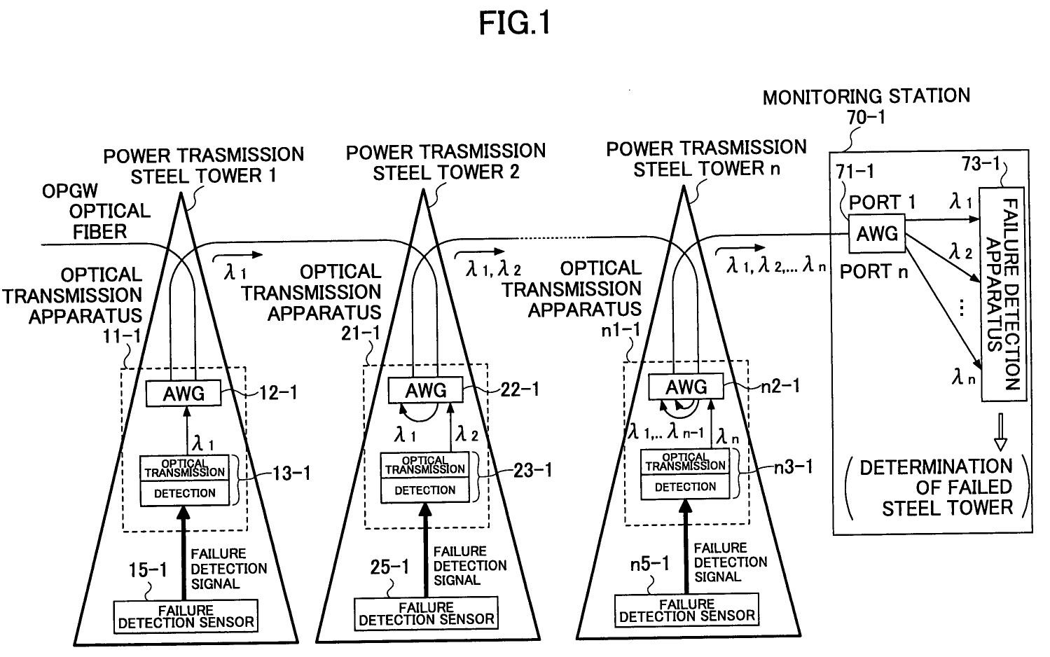

FIG. 1 is a diagram illustrating a configuration of a multipoint monitoring system according to a first embodiment of the present invention. In the multipoint monitoring system according to the present embodiment, steel towers 1 through n are connected to a monitoring station 70-1 by an OPGW optical fiber.

It is noted that in the first through sixth embodiments described below, monitoring stations are provided at both sides of the sequence of steel towers 1 through n; however, in the present drawing, only the right side monitoring station 70-1 is shown for the sake of simplicity.

At the steel towers 1 through n, failures occurring due to thunderbolts or collision with a flying object, for example, may be detected.

The occurrence of a failure detected in one of the steel towers 1 through n may be reported to the monitoring station by transmitting a corresponding unique wavelength of the wavelengths λ₁˜λₙ assigned to the steel towers 1 through n, respectively, as an optical failure detection signal.

For example, in a case where a failure occurs at steel tower 1, the wavelength λ₁ as an optical failure detection signal is transmitted to the steel tower 2 via the OPGW optical fiber. In a case where a failure also occurs at the steel tower 2, wavelength λ₂ as an optical failure detection signal is transmitted to the steel tower 3 via the OPGW optical fiber along with the wavelength λ₁ transmitted from the steel tower 1.

In this way, unique wavelengths assigned to the respective steel towers are multiplexed and transmitted. Accordingly, in a case where a failure occurs at each of the steel towers 1 through n, each of the corresponding wavelengths components λ₁˜λₙ may be transmitted to the monitoring station 70-1. It is noted that in the present embodiment, the configurations of the steel towers 1 through n are identical, and thereby, the steel tower 1 is described below as a representative example.

The steel tower 1 includes an optical transmission apparatus 11-1 and a failure detection sensor 15-1. The optical transmission apparatus includes an AWG unit 12-1, and an optical transmission unit 13-1. The AWG unit 12-1 includes an arrayed waveguide grating (referred to as AWG) The AWG unit 12-1 is arranged to conduct an optical wavelength add/drop operation on an optical signal supplied via the OPGW optical fiber.

According to the present embodiment, the AWG unit 12-1 is arranged to demultiplex a received optical signal into wavelength components and output the demultiplexed wavelength components. Then, the wavelength component λ₁ that is supplied from the optical transmission unit 13-1 as an optical failure detection signal is multiplexed with the demultiplexed wavelength components. Then the multiplexed optical failure detection signal is transmitted to the neighboring steel tower 2 via the OPGW optical fiber.

The optical transmission unit 13-1 is arranged to detect an optical failure detection signal that is generated at the failure detection sensor. In the present embodiment, the optical transmission unit 13-1 converts a failure detection signal corresponding to an electric signal to an optical failure detection signal. The optical failure detection signal, which is arranged to have a wavelength λ₁ that is unique to the steel tower 1, is supplied to the AWG unit 12-1.

The failure detection sensor 15-1 may be provided at a leg portion of a power transmission steel tower, for example, to detect an electrical failure of the steel tower occurring as a result of a thunder bolt or collision with a flying object, for example. In the present embodiment, the failure detection sensor 15-1 may be arranged to detect a sound generated as a result of a dielectric breakdown and produce a failure detection signal in the form of an electric signal upon detecting such a sound. This electric signal may correspond to a low speed on/off signal, for example.

The monitoring station 70-1 administers the maintenance and operation of the steel towers 1 through n residing within its monitoring area. In the present embodiment, the monitoring station 70-1 may be arranged to receive an optical failure detection signal transmitted from the OPWG optical fiber, and determine the operational states (occurrence of failure) of the steel towers 1 through n. The monitoring station 70-1 includes an AWG unit 71-1 and a failure detection apparatus 73-1.

In the present embodiment, the AWG 71-1 is arranged to demultiplex a received optical signal into wavelength components and output the demultiplexed wavelength components from their corresponding output ports 1 through n. It is noted that the respective optical signals output from the output ports 1 through n, corresponding to the steel towers 1 through n, are arranged to contain their corresponding wavelength components λ₁˜λₙ.

The failure detection apparatus 73-1 is arranged to determine whether a corresponding wavelength component is contained in an optical signal output from each of the output ports 1 through n of the AWG unit 71-1. According to the present embodiment, when the failure detection apparatus 73-1 detects the presence of a wavelength component, it determines that a failure is occurring at the corresponding steel tower.

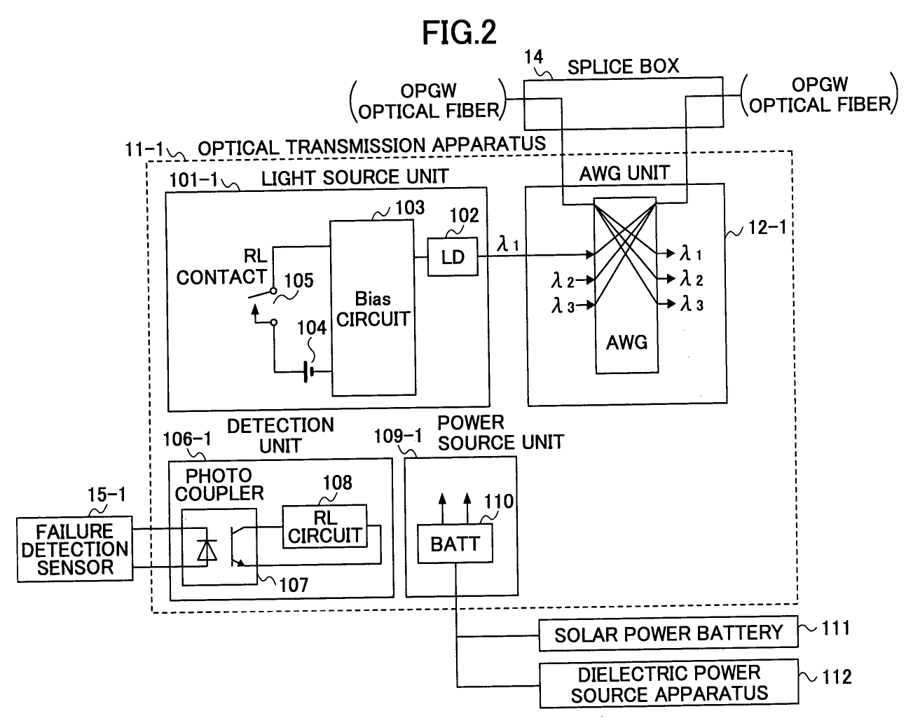

FIG. 2 is a block diagram showing a configuration of the optical transmission apparatus 11-1 that is implemented in the multipoint monitoring system according to the first embodiment of the present invention. The optical transmission apparatus 11-1 according to the present embodiment includes an AWG unit 12-1, a light source unit 101-1, a detection unit 106-1, and a power source unit 109-1. It is noted that the light source unit 101-1 and the detection unit 106-1 of this drawing are included in the optical transmission unit 13-1 of FIG. 1.

In the present embodiment, the detection unit 106-1 includes a photocoupler 107 and a relay (RL) circuit 108. The photocoupler 107 is arranged to receive a failure detection signal generated at the failure detection sensor 15-1, and block external noise. The relay circuit 108 is arranged to initiate its own operation upon receiving a failure detection signal.

The light source unit 101-1 includes a relay contact 105, a direct current source 104, a bias circuit 103, and a laser diode (LD) 102. The relay contact 105 is arranged to control the operation of the bias circuit 103.

According to the present embodiment, the relay contact 105 is arranged to open/close according to the operation of the relay circuit 108 of the detection unit 106-1, and the direct current source 104 is arranged to apply a voltage to the bias circuit 103 accordingly. In turn, the LD 102 is arranged to emit light in response to receiving a voltage from the bias circuit 103. The wavelength of the light to be emitted by the LD 102 is pre-arranged to be at wavelength λ₁.

The AWG unit 12-1 includes an AWG as described above, and an optical fiber for realizing pass through connection. In the present embodiment, the OPGW optical fiber is arranged to be connected to a predetermined input port and a predetermined output port of the AWG unit 12-1.

According to the present embodiment, a predetermined core wire of the OPGW optical fiber is used as an optical transmission line for monitoring. Specifically, a predetermined core wire is selectively drawn out from plural core wires of the OPGW optical fiber via a splice box 14, and is connected to the predetermined input port of the AWG unit 12-1.

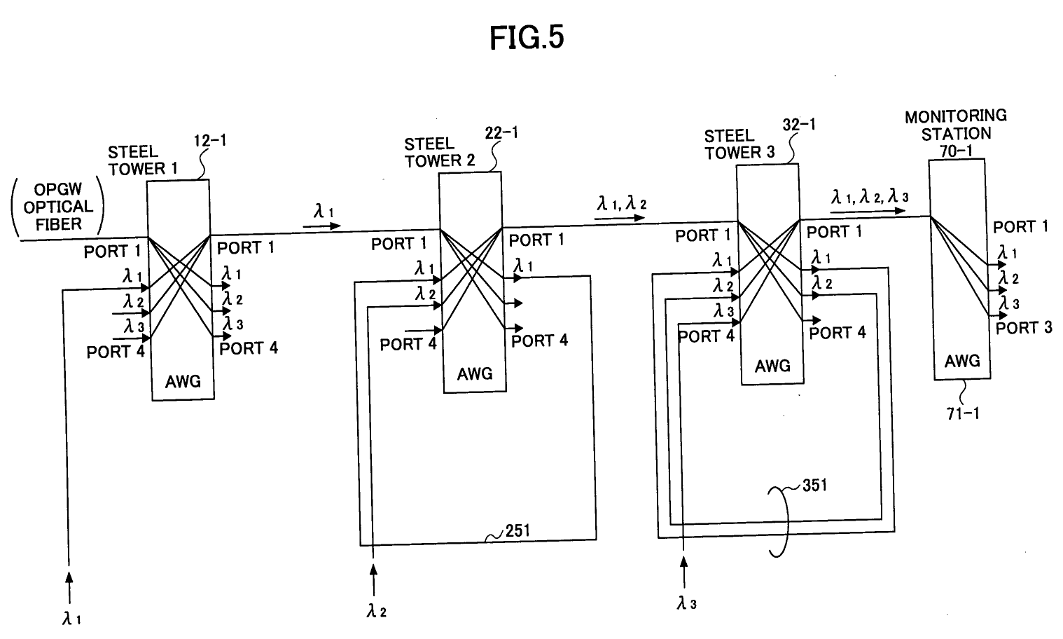

The AWG unit 12-1 is arranged to demultiplex an optical signal supplied from the predetermined input port into wavelength components (i.e., wavelength components λ₁, λ₂, and λ₃ in the example shown in FIG. 2), and output the demultiplexed wavelength components from corresponding output ports. In turn, the wavelength components output from the corresponding output ports are passed through their corresponding input ports via an optical fiber (see FIG. 5).

Also, in the present embodiment, the AWG unit 12-1 is arranged to receive an optical failure detection signal that is generated at the light source unit 101-1. In FIG. 1, the steel tower 1 is positioned at the left end of the monitoring area administered by the monitoring station 70-1, and thereby, in this example, a single wavelength component λ₁ corresponding to the steel tower 1 is multiplexed as an optical failure detection signal into the optical signal. This optical failure detection signal is then transmitted to the OPGW optical fiber toward the monitoring station 70-1.

It is noted that loss compensation may be conducted on the AWG unit 12-1 as necessary or desired in response to integration of a semiconductor optical amplifier, for example. Also, Raman amplification may be conducted in response to remote excitation from the monitoring station 70-1, for example.

The power source 109-1 includes a battery (BATT) 110, which is arranged to supply power to units such as the light source unit 101-1 and the detection unit 106-1 of the optical transmission apparatus 11-1. In the present example, the battery 110-1 is connected to a solar power battery 111 and a dielectric power source apparatus 112 to receive power source backup from these elements.

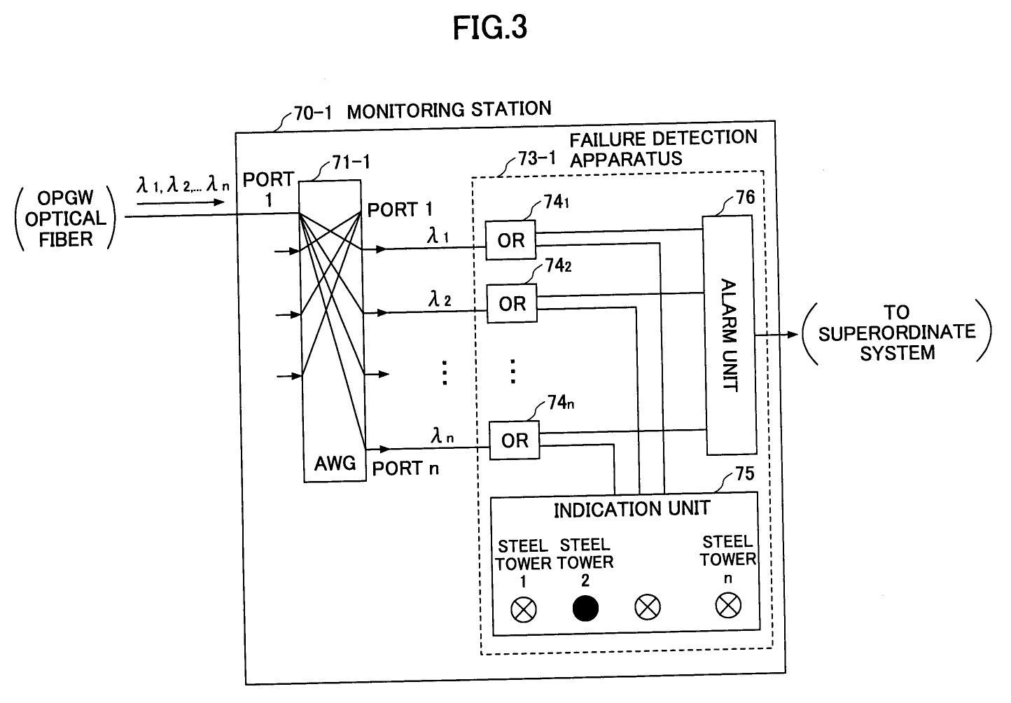

FIG. 3 is a block diagram showing a configuration of the monitoring station 70-1 implemented in the system according to the first embodiment. According to the present example, the monitoring station 70-1 includes an AGW 71-1 and a failure detection apparatus 73-1.

An input port 1 of the AWG unit 71-1 may be arranged to receive an optical failure detection signal transmitted via the OPGW optical fiber. The AWG 71-1 is arranged to demultiplex a received optical failure detection signal into wavelength components and output the demultiplexed wavelength components from corresponding output ports 1 through n. It is noted that in the present example, output ports 1 through n correspond to the steel towers 1 through n, respectively.

The failure detection apparatus 73-1 includes optical receivers (OR) 74₁ through 74ₙ, an indication unit 75, and an alarm unit 76. In the present example, the optical receivers (OR) 74₁ through 74ₙ are arranged to correspond to the output ports 1 through n of the AWG 71-1. For example, the optical receiver 74₁ is arranged to convert the wavelength component λₙ of an optical failure detection signal into an electric signal and transmit the converted signal to the indication unit 75 and the alarm unit 76.

The indication unit 75 is arranged to light up in order to enable visual recognition of the occurrence of a failure in response to receiving a failure detection signal supplied from a given one of the optical receivers (OR) 74₁ through 74ₙ. For example, upon receiving an electric signal input corresponding to the wavelength component λ₂, a lamp corresponding to the indication unit 75 of the steel tower 2 may light up. The alarm unit 76 is arranged to transmit a failure occurrence signal for a given steel tower n to a superordinate monitoring system in response to receiving a failure detection signal from a given one of the optical receivers (OR) 74₁ through 74ₙ. The superordinate system may correspond to a system that administers plural monitoring areas such as the monitoring area including the steel towers 1 through n and the monitoring station 70-1 as is illustrated in FIG. 1.

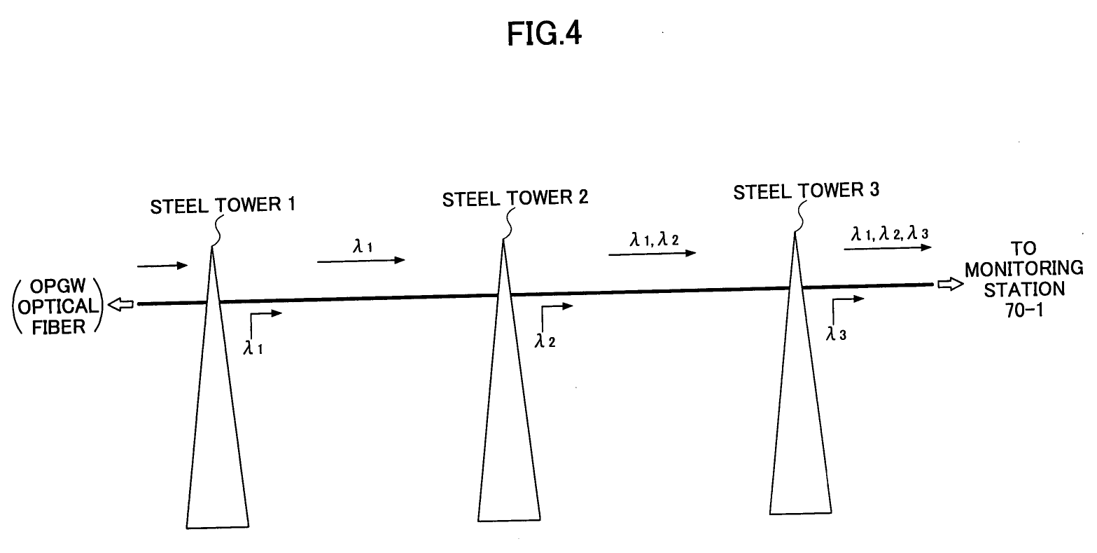

FIG. 4 illustrates a flow of the optical failure detection signal according to the first embodiment. In this drawing, optical failure detection signals that are simultaneously transmitted by the steel towers 1, 2, and 3 are illustrated.

According to the present example, when a failure occurs at the steel tower 1, an optical failure detection signal with wavelength λ₁ is generated and transmitted to the OPGW optical fiber at the monitoring station 70-1 side. When a failure occurs at the steel tower 2 at the same time, an optical failure detection signal with wavelength λ₂ is generated to be multiplexed with the optical failure detection signal with wavelength λ₁ and transmitted to the OPGW optical fiber on the monitoring station 70-1 side.

When a failure occurs at the steel tower 3 at the same time, an optical failure detection signal with wavelength λ₃ is generated to be multiplexed with the optical failure detection signals with wavelengths λ₁ and λ₂ and transmitted to the OPGW optical fiber on the monitoring station side 70-1. In this way, the optical failure detection signals from the steel towers 1, 2, and 3, respectively, are multiplexed and transmitted to the monitoring station 70-1.

FIG. 5 is a diagram illustrating connections of arrayed waveguide gratings according to the first embodiment. In this drawing, optical failure detection signal drop and add operations of AWG units 12-1, 22-1, and 32-1 provided at the steel towers 1, 2, and 3, respectively, are illustrated, the operations corresponding to the exemplary optical signal flow shown in FIG. 4.

At the steel tower 1, an optical failure detection signal with wavelength λ₁ that is unique to this particular steel tower 1 is supplied to an input port 2 of the AWG unit 12-1, and is then output from an output port 1 of the AWG unit 12-1 to be transmitted to the OPGW optical fiber on the monitoring station side 70-1.

At the steel tower 2, the optical failure detection signal with wavelength λ₁ from the steel tower 1 is demultiplexed and output from an output port 2 of the AWG unit 22-1. In turn, the demultiplexed wavelength component is passed through a pass connection optical fiber 251 to be supplied to an input port 2 of the AWG unit 22-1.

At the same time, an optical failure detection signal with wavelength λ₂ that is unique to the steel tower 2 is supplied to an input port 3 of the AWG unit 22-1. Then, the optical failure detection signals with wavelengths λ₁ and λ₂, respectively, are multiplexed and output from an output port 1 of the AWG unit 22-1 to be transmitted to the OPGW optical fiber on the monitoring station side 70-1.

At the steel tower 3, optical failure detection signals with wavelengths λ₁ and λ₂ that are supplied from the steel tower 2 side are demultiplexed and output from output ports 2 and 3 of the AWG unit 32-1, respectively. Then, the demultiplexed wavelength components are passed through pass connection optical fibers 351 to be supplied to input ports 2 and 3 of the AWG unit 32-1, respectively.

At the same time, an optical failure detection signal with wavelength λ₃ that is unique to the steel tower 3 is supplied to an input port 4 of the AWG unit 32-1. Then, the optical failure detection signals with wavelengths λ₁, λ₂ and λ₃, respectively, are multiplexed and output from an output port 1 of the AWG unit 32-1 to be transmitted to the OPGW optical fiber on the monitoring station side 70-1.

By establishing connection between the AWG units 12-1, 22-1, and 32-1 as is described above, optical failure detection signals having wavelengths unique to the steel towers 1, 2, and 3, respectively, may be successively multiplexed and transmitted to the monitoring station using the OPGW optical fiber as a transmission line.

In the illustrated example, the multiplexed optical failure detection signals from the steel tower 3 are received at an input port 1 of the AWG 71-1 of the monitoring station 70-1. In turn, the AWG 71-1 demultiplexes the received optical failure detection signals into wavelength components and outputs the demultiplexed wavelength components from output ports 1˜3, respectively.

In the example of FIG. 5, the wavelength components λ₁, λ₂ and λ₃ are output to the output ports 1, 2, and 3 of the monitoring station 70-1, respectively. In turn, the monitoring station 70-1 may determine that failures are occurring at the steel towers corresponding to the wavelength components output from its output ports.

As is described above, the multipoint monitoring system according to the present embodiment includes a failure detection sensor 15-1, an optical transmission unit 13-1, and an AWG unit 12-1. The failure detection sensor 15-1 is arranged to detect a failure (abnormality) in the steel tower 1. The optical transmission unit 13-1 is arranged to transmit an optical wavelength component λ₁ that is unique to the steel tower 1 at which a failure (abnormality) is detected. The AWG 12-1 is arranged to multiplex the optical wavelength component that is unique to the steel tower 1 for which a failure (abnormality) has been detected with wavelength components of an optical signal that is supplied from an OPGW optical fiber.

In a specific embodiment, the AWG unit 12-1 is arranged to demultiplex an optical signal supplied from the OPGW optical fiber into wavelength components, and multiplex an optical wavelength component transmitted from the optical transmission unit 13-1 and the demultiplexed wavelength components and output the multiplexed optical signal to the OPGW optical fiber.

In the following, a second embodiment of the present invention is described. It is noted that in the first embodiment as is described above, when one or more failures occur at steel towers 1 through n, wavelength components that are unique to the respective steel towers with the detected failures are successively multiplexed and transmitted to the monitoring station.

According to the present embodiment, unique wavelength components that are assigned to the respective steel towers of a monitoring area are multiplexed beforehand and supplied to the OPGW optical fiber. According to the present embodiment, when a failure occurs at a steel tower n, for example, a passage route for the corresponding unique wavelength component assigned to the steel tower n may be optically blocked at the steel tower n. Accordingly, it may be determined that a steel tower of which a corresponding wavelength component has not been received at a monitoring station corresponds to a steel tower at which a failure has occurred.

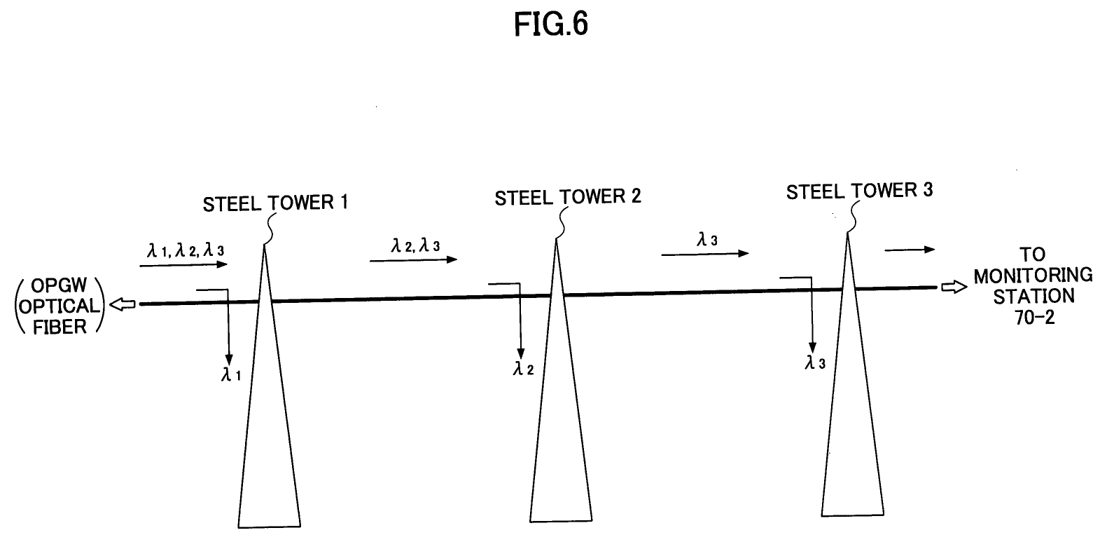

FIG. 6 is a diagram illustrating an exemplary flow of an optical failure detection signal according to the second embodiment. Specifically, this drawing illustrates a process flow in which a multi-wavelength optical failure detection signal including wavelength components λ₁, λ₂ and λ₃ corresponding to the steel towers 1, 2, and 3, respectively, are supplied to the steel tower 1 from a monitoring station positioned at the left hand side (not shown) wherein passage of the wavelength components λ₁, λ₂ and λ₃ are successively blocked in accordance with the detection of failures at the steel towers 1, 2, and 3, respectively.

According to this example, when a failure occurs at the steel tower 1, an optical failure detection signal with wavelength λ₁ of the multi-wavelength optical failure detection signal supplied to the steel tower 1 is blocked, and an optical failure detection signal with the remaining wavelength components λ₂ and λ₃ is supplied to the OPGW optical fiber on the monitoring station 70-2 side.

When a failure also occurs at the steel tower 2, an optical failure detection signal with wavelength λ₂ of the multi-wavelength optical failure detection signal with wavelengths λ₂ and λ₃ supplied from the steel tower 1 side is blocked, and an optical failure detection signal with the remaining wavelength component λ₃ is transmitted to the OPGW optical fiber on the monitoring station 70-2 side.

When a failure also occurs at the steel tower 3, the optical failure detection signal with wavelength λ₃ is blocked as well. According to this example, when failures occur at the steel towers 1, 2, and 3 simultaneously, an optical failure detection signal is not received at the monitoring station 70-2.

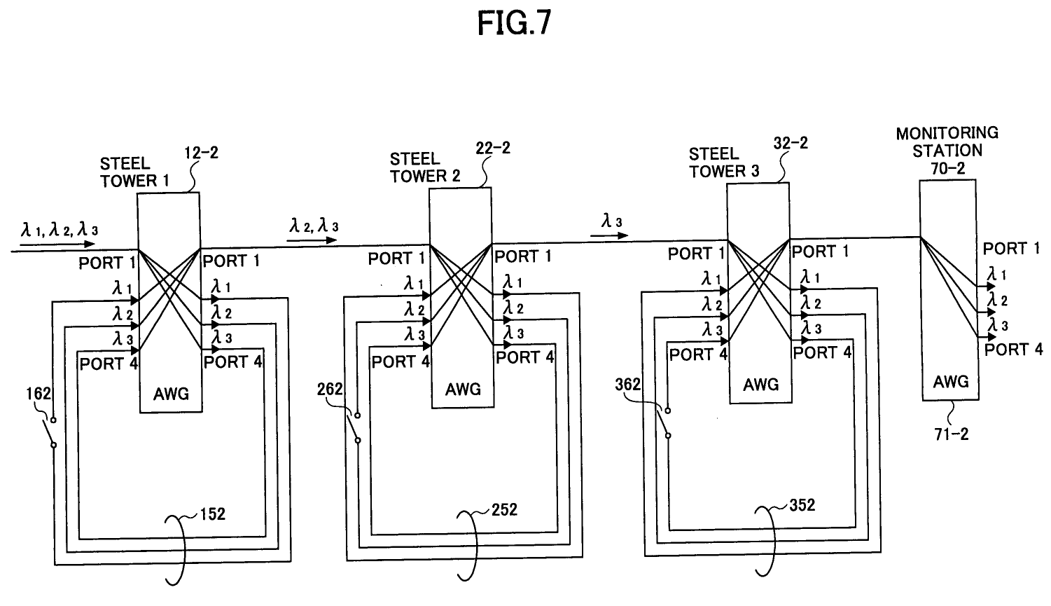

FIG. 7 is a diagram illustrating connections of arrayed waveguide gratings according to the second embodiment. In this drawing, drop and add operations of AWG units 12-2, 22-2, and 32-2 provided at the steel towers 1, 2, and 3, respectively, are shown, the illustrated operations corresponding to the exemplary optical failure detection signal flow shown in FIG. 6.

According to the present example, a multi-wavelength optical failure detection signal containing wavelength components λ₁, λ₂ and λ₃ is supplied to an input port 1 of the AWG 12-2. Then, the supplied optical failure detection signal is demultiplexed into the wavelength components to be output from output ports 2˜4, respectively. The demultiplexed wavelength components are then passed through their corresponding pass connection optical fibers 152 and supplied to input ports 2˜4 of the AWG unit 12-1.

According to the present example, an optical switch 162 is connected to a pass connection optical fiber for the wavelength component λ₁. This optical switch 162 is normally switched on, and is arranged to be switched off when a failure is detected in response to an optical signal that is supplied from the LD 102 (see FIG. 2).

In this way, the optical failure detection signal with the wavelength component λ₁ may be optically blocked in response to the detection of a failure occurring at the steel tower 1. Then, the remaining optical failure detection signals with wavelength components λ₂ and λ₃ are multiplexed and output from an output port 1 of the AWG unit 12-2 to be transmitted to the OPGW optical fiber at the monitoring station side 70-2.

It is noted that in the present example, the optical signal supplied from the LD 102 (see FIG. 2) functions as a trigger signal for blocking the wavelength component λ₁ that is unique to the steel tower 1 out of the wavelength components demultiplexed by the AWG unit 12-1. However, the present invention is not limited to this example, and the trigger signal may be directed to block wavelength components other than λ₁ as well.

At the steel tower 2, the optical failure detection signal with the wavelength components λ₂ and λ₃ is supplied to an input port 1 of the AWG unit 22-2. The supplied optical failure detection signal is then demultiplexed and output from output ports 3˜4, respectively. Then, the demultiplexed wavelength components are passed through their corresponding pass connection optical fibers 252 to be supplied to the input ports 3˜4 of the AWG unit 22-2.

According to the present example, an optical switch 262 is connected to the pass connection optical fiber 252 for the wavelength component λ₂. This optical switch 262 has a function identical to that of the optical switch 162 of the steel tower 1. In this way, the optical failure detection signal with the wavelength component λ₂ may be optically blocked in response to the detection of a failure occurring at the steel tower 2. Then, the remaining optical failure detection signal with the wavelength component λ₃ is output from an output port 1 of the AWG unit 22-2 and transmitted to the OPGW optical fiber on the monitoring station 70-2 side.

At the steel tower 3, the optical failure detection signal with the wavelength component λ₃ is supplied to an input port 1 of the AWG 32-2. Then the wavelength component is demultiplexed from the supplied signal to be output from an output port 4. Then, the demultiplexed wavelength component is passed through its corresponding pass connection optical fiber 352 to be supplied to an input port 4 of the AWG unit 32-2.

In the present example, an optical switch 362 is connected to the pass connection optical fiber for the wavelength component λ₃. This optical switch 362 has a function identical to that of the optical switch 162 of the steel tower 1. Accordingly, the optical failure detection signal with the wavelength component λ₃ may be optically blocked in response to the detection of a failure occurring at the steel tower 3. In such a case, an optical failure detection signal is not output from the output port 32-2.

As is described above, when failures occur at the steel towers 1, 2, and 3 simultaneously, an optical failure detection signal may not be supplied to the monitoring station 70-2. Consequently, lamps as indication units of the steel towers 1, 2, and 3, respectively, may not be turned on (lit up). According to the present example, it may be determined that steel towers 1, 2, and 3 whose corresponding lamps are not lit correspond to the steel towers at which failures are detected.

As can be appreciated from the above description, a multipoint monitoring system according to the present embodiment includes a failure detection sensor 15-2, an AWG unit 12-2, an optical transmission unit 13-1, and an optical switch 162. The failure detection sensor 15-2 is arranged to detect a failure occurring at a steel tower 1, for example. The AWG 12-2 is arranged to demultiplex an optical signal supplied from an OPGW optical fiber containing multiplexed wavelength components unique to the respective steel towers being monitored into the respective wave length components.

The optical switch is arranged to use the outputs of the failure detection sensor 15-2 and the optical transmission unit 13-1 to block a wavelength component that is unique to a monitoring point (steel tower) at which an abnormality (failure) is detected out of the wavelength components obtained by the demultiplexing operation of the AWG unit 12-2. The AWG 12-2 is arranged to multiplex the demultiplexed wavelength components other than that blocked by the optical switch 162, and output the multiplexed signal to the OPGW optical fiber.

In a specific embodiment, the optical switch 162 is provided within a pass connection optical fiber 152 that connects an output port of the AWG unit 12-2 to a corresponding input port. The optical switch 162 is arranged to optically block a wavelength component that is unique to a steel tower at which a failure is detected out of the wavelength components obtained by the demultiplexing operation of the AWG 12-2.

It is noted that the monitoring stations 70-1 and 70-2 according to the first and second embodiments each include an AWG 71-1/71-2, and an indication unit 75. The AWG 71-1/71-2 is arranged to demultiplex an optical failure detection signal supplied from the OPGW optical fiber into wavelength components. The indication unit 75 is arranged to indicate the monitoring point (e.g., steel tower) at which an abnormality (e.g., failure) is occurring based on the wavelength components supplied from the AWG 71-1/71-2. It is also noted that in the first and second embodiments, the indication unit 75 is used to visually indicate the steel tower at which a failure is occurring. However, the present invention is not limited to such an indication unit 75, and other means for indicating the steel tower at which a failure is occurring may be used as well.

In the following, third and fourth embodiments of the present invention are described. The third and fourth embodiments correspond to the first and second embodiments, respectively, with moving image transmitting functions added thereto.

According to the embodiments implementing the moving image transmitting function, an image indicating a state of a steel tower may be captured and stored in response to an occurrence of a failure at the steel tower. Also, a predetermined moving image (e.g., memory image, online image) may be transmitted to a monitoring station in response to a request from the monitoring station. In this case, the moving image may be transmitted via the OPGW optical fiber using the AWG.

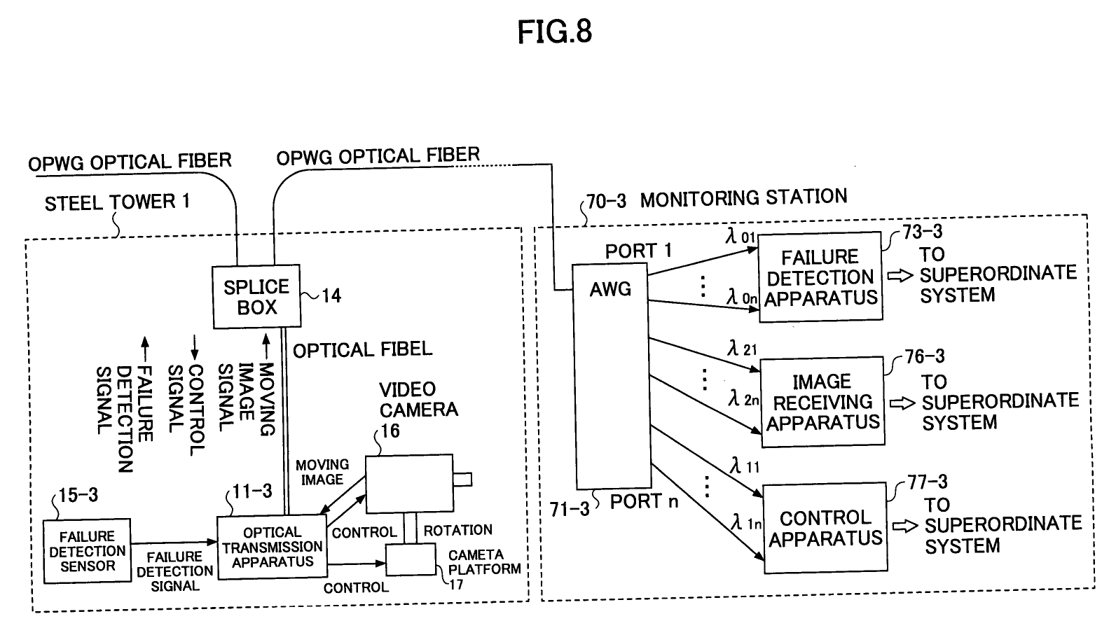

FIG. 8 shows a configuration of a multipoint monitoring system according to the third embodiment of the present invention. It is noted that the configuration of FIG. 8 corresponds to that of FIG. 1 illustrating the first embodiment, and in this drawing, the steel tower 1 and a monitoring station 70-3 are shown.

According to the present embodiment, the OPGW optical fiber is connected to the steel tower 1, and a core wire of the OPGW optical fiber for realizing the present monitoring operation is inserted into an optical transmission apparatus 11-3 using a splice box 14 of the steel tower 1.

The core wire for realizing the monitoring operation may be used as a transmission line for transmitting a multiplexed signal including optical failure detection signals as well as control signals and moving image signals. The control signal may include instructions pertaining to capturing and transmitting a moving image representing a state of the steel tower 1 when a failure occurs in the steel tower 1, for example.

According to the present embodiment, unique wavelengths are assigned to each steel tower. In this drawing, the wavelength of the optical failure detection signal that is transmitted in response to the occurrence of a failure within a steel tower n is denoted as λ₀ₙ, the wavelength of the control signal pertaining to a moving image transmission request, for example, that is transmitted in response to this optical failure detection signal is denoted as λ₁ₙ, and the wavelength of the moving image signal that is transmitted to the monitoring station 70-3 in response to the control signal is denoted as λ₂ₙ.

By realizing optical transmission of a control signal with a wavelength that is unique to a given steel tower, the optical transmission apparatus 11-3 may be able to distinguish the control signal from signals for other steel towers so as to receive and process the corresponding control signal for the given steel tower. Also, by realizing optical transmission of a moving image signal with a wavelength unique to a given steel tower, the monitoring station may be able to distinguish this moving image signal from signals from other steel towers so as to receive a desired moving image signal pertaining to the given steel tower.

According to the present embodiment, an operation of the optical transmission apparatus 11-3 may include the following process steps.

First, an optical failure detection signal is sent to the monitoring station 70-3 in response to the generation of a failure detection signal at the failure detection sensor 15-3.

Second, communication pertaining to the generation of a control signal is made from the monitoring station 70-3 positioned at the right side to a monitoring station (not shown) positioned at the left side of the monitoring area.

Third, a video camera 16 and a camera platform 17 are controlled based on a control signal from the monitoring station positioned at the left side, and a moving image representing the state of the steel tower 1 is captured and stored.

Fourth, the moving image that is captured and stored is transmitted based on the control signal from the monitoring station positioned at the left side.

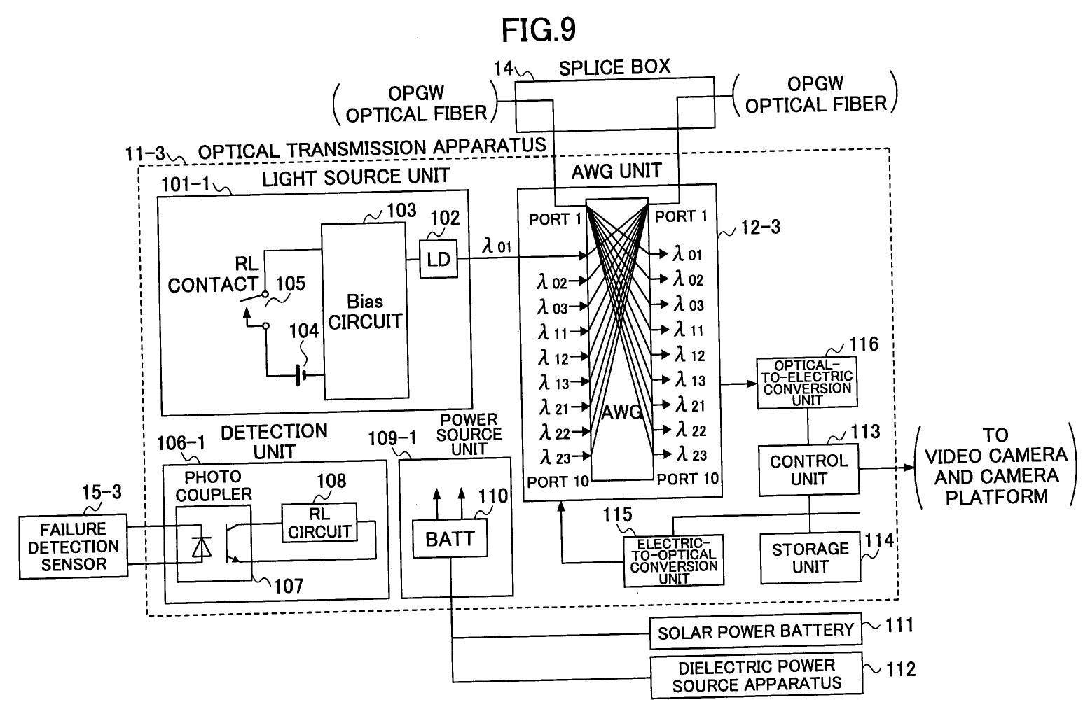

In the present example, the video camera 16 is used to capture a moving image representing the state of the steel tower 1 and it surroundings. In the present example, the video camera 16 is arranged to capture a memory image and an online image. The memory image is captured based on an instruction from a control unit 113 (see FIG. 9) that is generated in response to the detection of a failure. The online image is used by the monitoring station 70-3 to make a further detailed analysis of the failure state of the steel tower 1 after making an analysis from the memory image.

As is shown in the drawing, the monitoring station 70-3 includes an AWG 71-3, a failure detection apparatus 73-3, an image receiving apparatus 76-3, and a control apparatus 77-3. The AWG 71-3 demultiplexes an optical signal received from the OPGW optical fiber into wavelength components and outputs the demultiplexed wavelength components from output ports 1 through n.

According the present example, optical signals with wavelengths λ₀₁ through λ₀ₙ are input to the failure detection apparatus 73-3 and converted by optical receivers (see FIG. 3) to determine the steel tower at which a failure has occurred. The determination result may then be sent to a superordinate system. Also, optical signals with wavelengths λ₂₁ through λ₂ₙ are input to the image receiving apparatus 76-3, and processed by optical receivers (see FIG. 3) to identify the state of the steel tower at which a failure is occurring. The identification result may also be transmitted to a superordinate system. Also, optical signals with wavelengths λ₁₁, through λ₁ₙ are input to the control apparatus 77-3.

FIG. 9 is a diagram showing a configuration of the optical transmission apparatus 11-3 that used in the multipoint monitoring system according to the third embodiment. It is noted that the configuration shown in FIG. 9 generally corresponds to that of FIG. 2 that is illustrated in relation to the first embodiment, and thereby, elements shown in FIG. 9 that are identical to those shown in FIG. 2 are represented by the same numerical references and their descriptions are omitted.

In the present example, the optical transmission apparatus 11-3 is provided within the steel tower 1, and includes a light source 101-1, a detection unit 106-1, a power source unit 109-1, an AWG unit 12-3, a control unit 113, a storage unit 114, an electric-to-optical conversion unit 115, and an optical-to-electric conversion unit 116.

According to the present embodiment, the OPGW optical fiber passes through a splice box 14 at which a core wire that is used as a transmission line for monitoring is picked out and inserted to the optical transmission apparatus 11-3. The transmission line for monitoring may be used to input a multiplexed signal including control signals with unique wavelengths λ₁₁ through λ₁ₙ for the steel towers 1 through n to the AWG unit 12-3.

According to the present embodiment, the AWG unit 12-3 is used to realize three major functions. First, the AWG unit 12-3 is arranged to receive a control signal in a multiplexed state at a predetermined input port. In turn, at the AWG unit 12-3, the control signal is demultiplexed into wavelength components and output from predetermined output ports, after which the wavelength components are supplied to their corresponding input ports. It is particularly noted that the control signal with wavelength λ₁₁ is used by the control unit 113 to conduct transmission processes of a moving image.

Second, the AWG unit 12-3 is arranged to receive an optical failure detection signal with a wavelength λ₀₁ that is unique to the steel tower 1 at a predetermined input port. Third, the AWG unit 12-3 is arranged to receive a moving image signal that is to be transmitted with wavelength λ₂₁ at a predetermined input port in response to the control signal with the wavelength λ₁₁. Thus, according to the present embodiment, optical failure detection signals, moving image signals and control signals are multiplexed and output from a predetermined output port of the AWG unit 12-3.

The control unit 113 may correspond to a microprocessor that generates instructions based on multi-wavelength control signals supplied from a monitoring station (not shown) positioned at the right side of the monitoring area shown in FIG. 8, for example. In the present example, the control unit 113 uses the control signal with the wavelength λ₁₁ that is unique to the steel tower 1. Specifically, the control unit 113 directs the execution of three major operations based on a control signal that is converted into an electric signal by the optical-to-electric conversion unit 116.

First, the control unit 113 is arranged to instruct units such as the video camera 16 and the camera platform 17 to capture a moving image of the state of the steel tower in response to the occurrence of a failure at the steel tower 1. The image capturing instruction generated by the control unit 113 may include initial instructions as well as additional instructions from the monitoring station positioned at the left side, for example. The instructions may include information pertaining to brightness adjustment, height, and rotation of the video camera 16, and information pertaining to the height of the camera platform 17, for example.

Second, the control unit 113 is arranged to direct the transmission of a captured and stored memory image in response to the image capturing instruction. This transmission direction includes an instruction for the electric-to-optical conversion unit 115 to convert an electric signal into an optical signal. Third, the control unit 113 is arranged to direct the transmission of an online image from the monitoring station positioned at the left side in response to the transmission of the memory image. This transmission direction also includes an instruction for the electric-to-optical conversion unit 115 to convert an electric signal into an optical signal.

The storage unit 114 may correspond to a RAM (random access memory) that is arranged to store moving image information captured by the video camera 16 according to an instruction from the control unit 113, for example. The electric-to-optical conversion unit 115 is arranged to convert the moving image information stored in the storage unit 114 into an optical signal according to an instruction from the control unit 113. It is noted that in the present example, the moving image signal in the form of an optical signal has a wavelength λ₂₁ that is unique to the steel tower 1. The optical-to-electrical conversion unit 116 is arranged to convert a control signal from the AWG unit 12-3 in the form of an optical signal into a control signal in electric signal format.

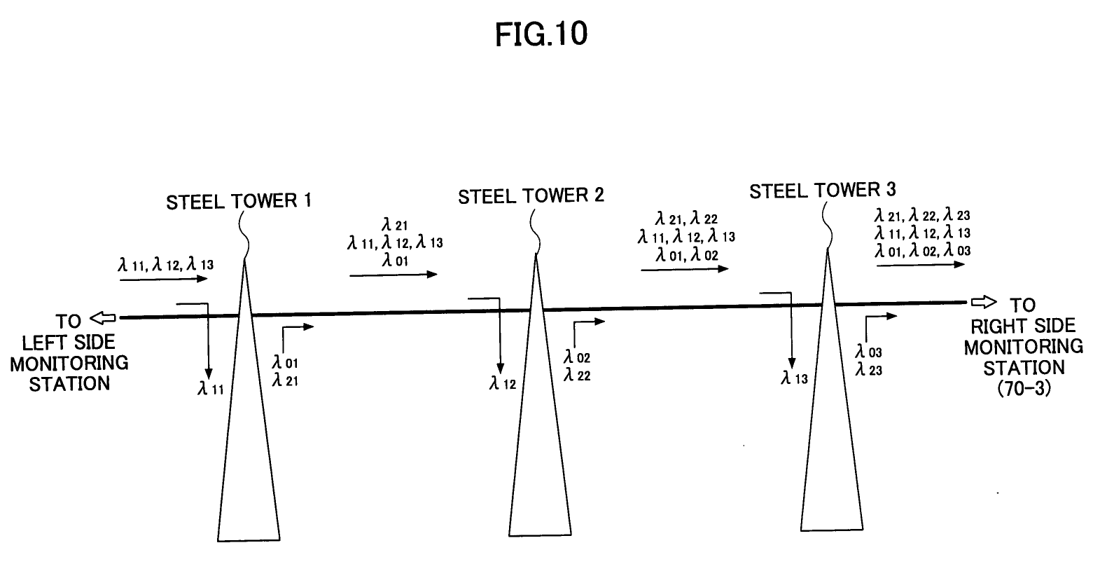

FIG. 10 shows an exemplary signal flow of optical failure detection signals, control signals, and moving image signals according to the third embodiment. It is noted that the exemplary signal flow shown in this drawing corresponds to that illustrated in relation to the first embodiment (see FIG. 4). That is, this drawing illustrates a case in which optical failure detection signals with wavelengths λ₀₁, λ₀₂, and λ₀₃ that are transmitted from the steel towers 1, 2, and 3, respectively, control signals with wavelengths λ₁₁, λ₁₂, and λ₁₃, and moving image signals with wavelengths λ₂₁, λ₂₂, and λ₂₃ are simultaneously transmitted.

According to the present example, first, control signals with wavelengths λ₁₁, λ₁₂, and λ₁₃ are multiplexed and input to the steel tower 1. At the steel tower 1, the control signal with the wavelength λ₁₁ that is unique to the steel tower 1 is used. Also, an optical failure detection signal with wavelength λ₀₁ and a moving image signal with wavelength λ₂₁ are generated at the steel tower 1 and multiplexed with the control signals with wavelengths λ₁₁, λ₁₂, and λ₁₃ to be transmitted to the OPGW optical fiber on the monitoring station 70-3 side.

At the steel tower 2, the control signal with the wavelength λ₁₂ that is unique to the steel tower 2 is used. Also, an optical failure detection signal with wavelength λ₀₂ and a moving image signal with wavelength λ₂₂ are generated at the steel tower 2 and multiplexed with the control signals with wavelengths λ₁₁, λ₁₂, and λ₁₃, the optical failure detection signal with wavelength λ₀₁, and the moving image signal with wavelength λ₂₁ to be transmitted to the OPGW optical fiber on the monitoring station 70-3 side.

At the steel tower 3, the control signal with the wavelength λ₁₃ that is unique to the steel tower 3 is used. Also, an optical failure detection signal with wavelength λ₀₃ and a moving image signal with wavelength λ₂₃ are generated at the steel tower 3 and multiplexed with the control signals with wavelengths λ₁₁, λ₁₂, and λ₁₃, the optical failure detection signals with wavelengths λ₀₁ and λ₀₂, and the moving image signals with wavelengths λ₂₁ and λ₂₁ to be transmitted to the OPGW optical fiber on the monitoring station 70-3 side.

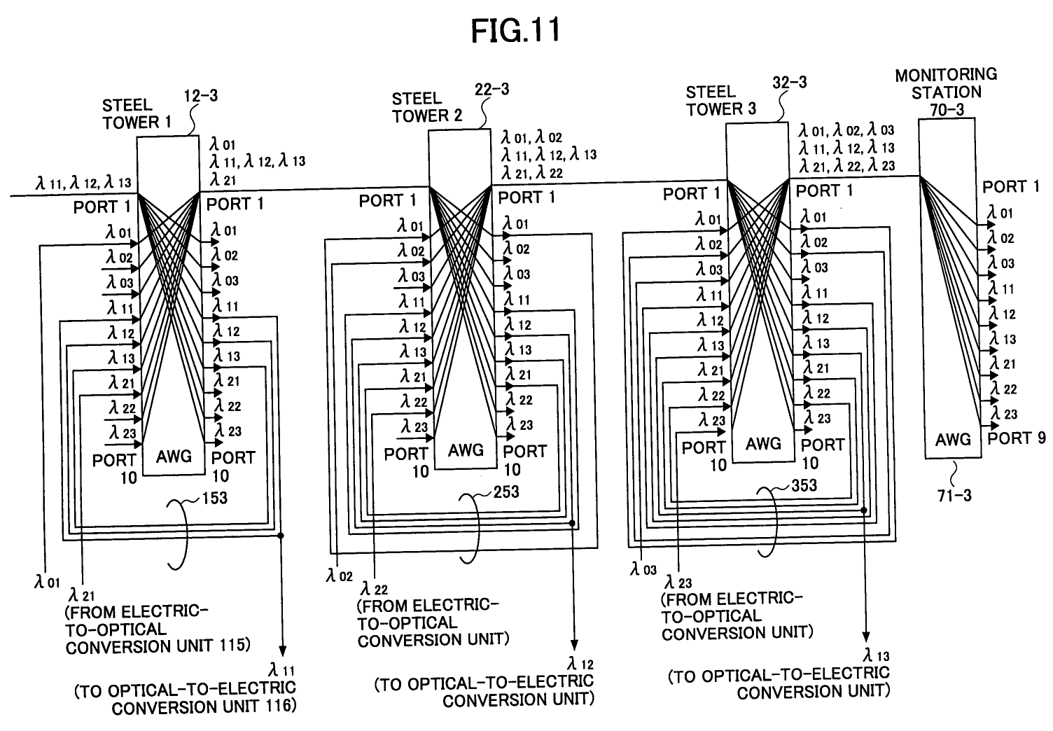

FIG. 11 is a diagram illustrating connections of arrayed waveguide gratings according to the third embodiment. This drawing illustrates exemplary drop and add operations executed on optical failure detection signals, moving image signals, and control signals by the AWG units 12-3, 22-3, and 32-3 implemented in the steel towers 1, 2, and 3, respectively. It is noted that the illustrated operations correspond to those executed in accordance with the exemplary signal flow shown in FIG. 10.

According to the present example, at the steel tower 1, control signals with wavelengths λ₁₁, λ₁₂, and λ₁₃ are multiplexed and supplied to an input port 1 of the AWG unit 12-3. Also, an optical failure detection signal with wavelength λ₀₁, is supplied to an input port 2 of the AWG unit 12-3.

In turn, the AWG unit 12-3 demultiplexes the control signals into wavelength components, and outputs optical signals with the demultiplexed wavelength components from their corresponding output ports 5 through 7. The wavelength components are then passed through pass connection optical fibers 153 to be supplied to their corresponding input ports 5 though 7. The control signal with the wavelength λ₁₁ is demultiplexed from the pass connection optical fiber 153 and supplied to the optical-to-electrical conversion unit 116.

Also, a moving image signal with wavelength λ₂₁ that is supplied from the electric-to-optical conversion unit 115 is supplied to an input port 8 of the AWG unit 12-3. In turn, the optical failure detection signal with wavelength λ₀₁, the control signals with wavelengths λ₁₁, λ₁₂, and λ₁₃, and the moving image signal with wavelengths λ₂₁ are multiplexed and output from an output port 1 of the AWG unit 12-3 to be transmitted to the OPGW optical fiber on the monitoring station 70-3 side.

At the steel tower 2, the multiplexed optical signal from the steel tower 1 is supplied to an input port 1 of the AWG unit 22-3. Also, an optical failure detection signal with wavelength λ₀₂ is supplied to an input port 3 of the AWG unit 22-3. In turn, the AWG unit 22-3 demultiplexes the multiplexed optical signal into wavelength components and outputs the wavelength components from the output ports 2, 5˜8.

Then, the demultiplexed wavelength components are passed through pass connection optical fibers 253 to be supplied to their corresponding input ports 2, 5˜8. The control signal with the wavelength λ₁₂ is demultiplexed from the pass connection optical fiber 253 to be supplied to an optical-to-electric conversion unit (not shown) of the steel tower 2.

Also, a moving image signal with wavelength λ₂₂ that is supplied from an electric-to-optical conversion unit (not shown) of the steel tower 2 is supplied to an input port 9 of the AWG unit 22-3. Accordingly, the optical failure detection signals with wavelength components λ₀₁ and λ₀₂, control signals with wavelength components λ₁₁, λ₁₂, and λ₁₃, and the moving image signals with wavelengths λ₂₁ and λ₂₂ are multiplexed and output from an output port 1 of the AWG unit 22-3 to be transmitted to the OPGW optical fiber on the monitoring station 70-3 side.

At the steel tower 3, the multiplexed optical signal from the steel tower 2 is supplied to an input port 1 of the AWG unit 32-3. Also, an optical failure detection signal with wavelength λ₀₃ is supplied to an input port 4 of the AWG unit 32-3. In turn, the AWG unit 32-3 demultiplexes the multiplexed optical signal into wavelength components and outputs the wavelength components from the output ports 2, 3, 5˜9.

Then, the demultiplexed wavelength components are passed through pass connection optical fibers 353 to be supplied to their corresponding input ports 2, 3, 5˜9. The control signal with the wavelength λ₁₃ is demultiplexed from the pass connection optical fiber 353 to be supplied to an optical-to-electric conversion unit (not shown) of the steel tower 3.

Also, a moving image signal with wavelength λ₂₃ that is supplied from an electric-to-optical conversion unit (not shown) of the steel tower 3 is supplied to an input port 10 of the AWG unit 32-3. Accordingly, the optical failure detection signals with wavelength components λ₀₁, λ₀₂, and λ₀₃, control signals with wavelength components λ₁₁, λ₁₂, and λ₁₃, and the moving image signals with wavelengths λ₂₁, λ₂₂, and λ₂₃ are multiplexed and output from an output port 1 of the AWG unit 32-3 to be transmitted to the OPGW optical fiber on the monitoring station 70-3 side.

Then, the multiplexed optical signal from the output port 1 of the steel tower 3 is received at an input port 1 of an AWG 71-3 of the monitoring station 70-3. In turn, the multiplexed optical signal is demultiplexed into wavelength components to be output from their corresponding output ports. For example, the optical failure detection signals with wavelength components λ₀₁˜λ₀₃ may be output from output ports 1˜3 of the AWG 71-3, the control signals with wavelengths λ₁₁˜λ₁₃ may be output from output ports 4˜6, and the moving image signals with wavelengths λ₂₁˜λ₂₃ may be output from output ports 7˜9.

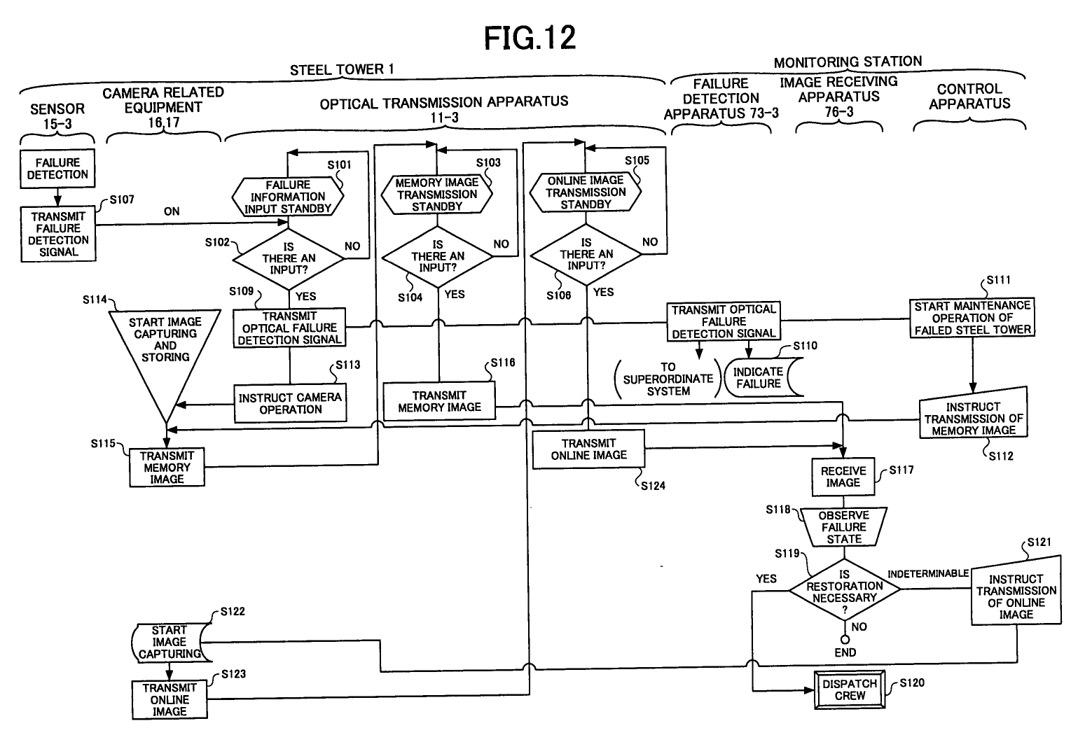

FIG. 12 is a flowchart illustrating operational steps pertaining to transmission of a moving image that is conducted in the multipoint monitoring system according to the third embodiment.

According to the present example, initially, the three major functional operations of the optical transmission apparatus 11-3 are each set to a standby mode. The standby modes of the optical transmission apparatus 11-3 are controlled by the control unit 113. In step S101, the optical transmission apparatus 11-3 is in a failure detection signal input standby mode, and in step S102, a determination is made as to whether a failure detection signal is input.

In step S103, the optical transmission apparatus 11-3 is in a memory image transmission standby mode, and in step S104, a determination is made as to whether a memory image has been input. Also, in step S105, the optical transmission apparatus 11-3 is in an online image transmission standby mode, and in step S106 a determination is made as to whether an online image is input.

It is noted that process steps following the steps S101 and S102, the steps S103 and S104, and the steps S105 and S106 may not necessarily have to be conducted in the order as described below. In other words, in the following, an exemplary process sequence according to a preferred embodiment is described; however the present invention is not limited to this particular embodiment.

In step S107, a failure detection signal is sent to the optical transmission apparatus 11-3 in response to a detection of a failure at the failure detection sensor 15-3. In turn, at the optical transmission apparatus 11-3, a positive determination is made in step S102, and in step S109, an optical failure detection signal with wavelength λ₀₁ is generated and transmitted to the failure detection apparatus 73 of the monitoring station 70-3 via the AWG unit 12-3. Then, in step S110, the optical failure detection signal is indicated at an indication unit (see FIG. 3), and the failure is reported to a superordinate system by an alarm unit (see FIG. 3).

Then, in step S111, a control apparatus provided in the monitoring station (not shown) positioned on the left side of the monitoring area of FIG. 8 initiates a maintenance operation on the failed steel tower 1 in response to the transmission of the optical failure detection signal at the failure detection apparatus 73-3, and in step S112, the control apparatus transmits a control signal with wavelength λ₁₁ as an instruction to transmit a memory image.

Also, at the optical transmission apparatus 11-3, after step S109, the operation proceeds to step S113 in which the control unit 113 (see FIG. 9) of the optical transmission apparatus 11-3 transmits initial instructions pertaining to camera operations to the video camera 16 and the camera platform 17 in response to the generation of the optical failure detection signal; namely, in response to operations of the RL contact 105 or the bias circuit 103, for example. In step S114, the video camera 16 initiates an image capturing operation for capturing a moving image of the state of the failed steel tower 1. The captured moving image information may be successively stored in the storage unit 114 as a memory image.

Then, in step S115, the following operation processes are conducted. First, the optical-to-electrical conversion unit 116 converts the control signal with wavelength λ₁₁ that is transmitted from the AWG unit 12-3 into an electrical signal in response to an instruction from the control unit 113 of the optical transmission apparatus 11-3.

In turn, the control unit 113 successively reads the memory image information stored in the storage unit 114 based on the electrically converted control signal. Then, the electric-to-optical conversion unit 115 converts the memory image information read from the storage unit 114 into an optical signal with wavelength λ₂₁ (moving image signal) and transmits the optically converted signal to the control unit 113.

Then, the operation proceeds to steps S103 and S104 that are described above, and then to step S116 in which the optical transmission apparatus 11-3 transmits the moving image signal transmitted from the control unit 113 to the image receiving apparatus 76-3 of the monitoring station 70-3. Then, in step S117, the image receiving apparatus 76-3 receives the moving image signal from the optical transmission apparatus 11-3, and in step S118, observation may be made from the memory image to asses the failure state of the steel tower 1.

Then, in step S119, a determination is made at the monitoring station as to whether restoration of the steel tower 1 is necessary. When it is determined that restoration is necessary (S119, YES), a crew may be dispatched to the site of the steel tower 1 (S120). When it cannot be determined whether restoration is necessary, the operation proceeds to step S121 in which the control apparatus of the monitoring station positioned on the left side transmits a control signal with wavelength λ₁₁ to the optical transmission apparatus 11-3 as a transmission instruction for instructing the transmission of an online image. It is noted that this control signal may include additional image capturing instructions for the video camera 16 along with the image transmission instructions, for example.

In turn, the optical-to-electrical conversion unit 116 of the optical transmission apparatus 11-3 converts the optical control signal with wavelength λ₁₁ that is transmitted from the AWG unit 12-3 into an electrical signal in response to an instruction from the control unit 113. The control unit 113 sends an image capturing instruction to the video camera 16 based on the electrically converted control signal.

In step S122, an online image is captured in response to the image capturing instruction from the control unit 113. Then, in step S123, the online image is transmitted to the electric-to-optical conversion unit 115. The electric-to-optical conversion unit 115 converts the online image from the video camera 16 into an optical signal with wavelength λ₂₁ (moving image signal) in response to an instruction from the control unit 113.

Then, the operation proceeds to step S124 via steps S105 and S106. In step S124, the optically converted online image signal is transmitted from the optical transmission apparatus 11-3 to the monitoring station 70-3. Then, the operation processes of steps S117˜119 and steps S121˜S124 may repeated until it is determined in step S119 that restoration is unnecessary.

In the following, a multipoint monitoring system according to a fourth embodiment of the present invention is described. It is noted that the fourth embodiment corresponds to the second embodiment with the above-described moving image transmission function added thereto. According to the fourth embodiment, failure detection information is conveyed from a steel tower to a monitoring station, and at the same time, a moving image representing the state of the facilities of the failed steel tower is captured by a digital camera that is provided at this steel tower, and the captured moving image is transmitted to the monitoring station.

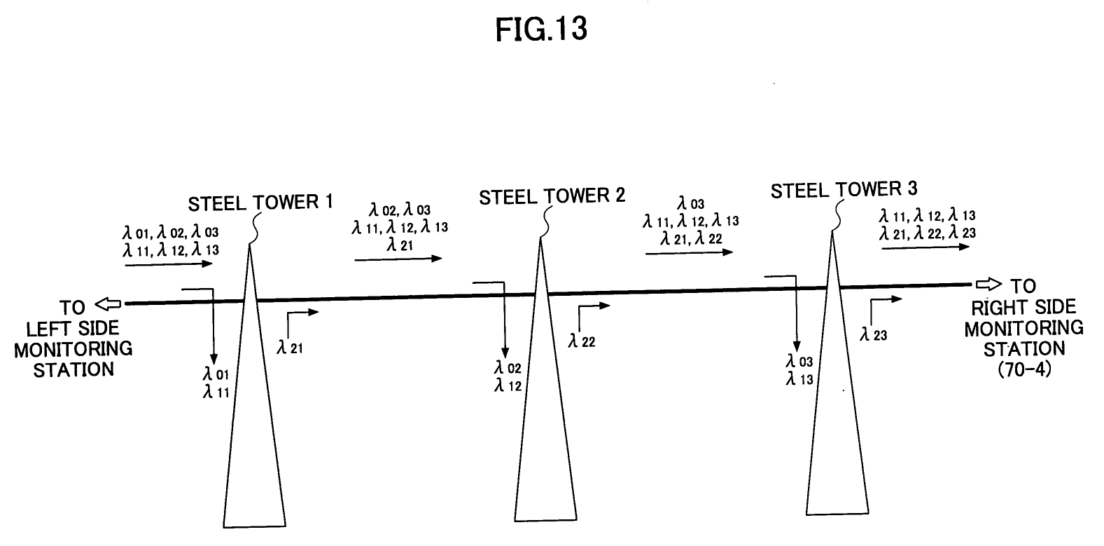

FIG. 13 is a diagram illustrating an exemplary signal flow of optical failure detection signals, control signals, and moving image signals according to the fourth embodiment. It is noted that the exemplary signal flow shown in this drawing corresponds to the signal flow illustrated in relation to the second embodiment (see FIG. 6). In other words, FIG. 13 illustrates the flow of signals in a case where optical failure detections signals with wavelengths λ₀₁, λ₀₂, and λ₀₃ that are transmitted from the steel towers 1, 2, and 3, respectively, control signals with wavelengths λ₁₁, λ₁₂, and λ₁₃, and moving image signals with wavelengths λ₂₁, λ₂₂, and λ₂₃ are simultaneously transmitted.

According to the present example, first, optical failure detection signals with wavelengths λ₀₁, λ₀₂, and λ₀₃, and control signals with wavelengths λ₁₁, λ₁₂, and λ₁₃ are multiplexed and input to the steel tower 1. When a failure occurs at the steel tower 1, the optical failure detection signal with wavelength λ₀₁ is blocked and the control signal with the wavelength λ₁₁ is used. Then, the remaining optical failure detection signals with wavelengths λ₀₂ and λ₀₃, and control signals with wavelengths λ₁₁, λ₁₂, and λ₁₃, are multiplexed with a moving image signal with wavelength λ₂₁ and transmitted to the OPGW optical fiber on the monitoring station 70-4 side.

When a failure also occurs at the steel tower 2, the wavelength component λ₀₂ is blocked and the control signal with the wavelength λ₁₂ is used. Then the remaining optical failure detection signal with wavelength λ₀₃, the control signals with wavelengths λ₁₁, λ₁₂, and λ₁₃, and the moving image signal with wavelength λ₂₁ are multiplexed with a moving image signal with wavelength λ₂₂ to be transmitted to the OPGW optical fiber on the monitoring station 70-4 side.

When a failure also occurs at the steel tower 3, the optical failure detection signal with wavelength λ₀₃ is blocked and the control signal with the wavelength λ₁₃ is used. Then, the remaining control signals with wavelengths λ₁₁, λ₁₂, and λ₁₃, and the moving image signals with wavelengths λ₂₁ and λ₂₁ are multiplexed with a moving image signal with wavelength λ₂₃ to be transmitted to the OPGW optical fiber on the monitoring station 70-4 side. According to this example, when failures occur at the steel towers 1, 2, and 3 simultaneously, an optical failure detection signal is not transmitted to the monitoring station 70-2.

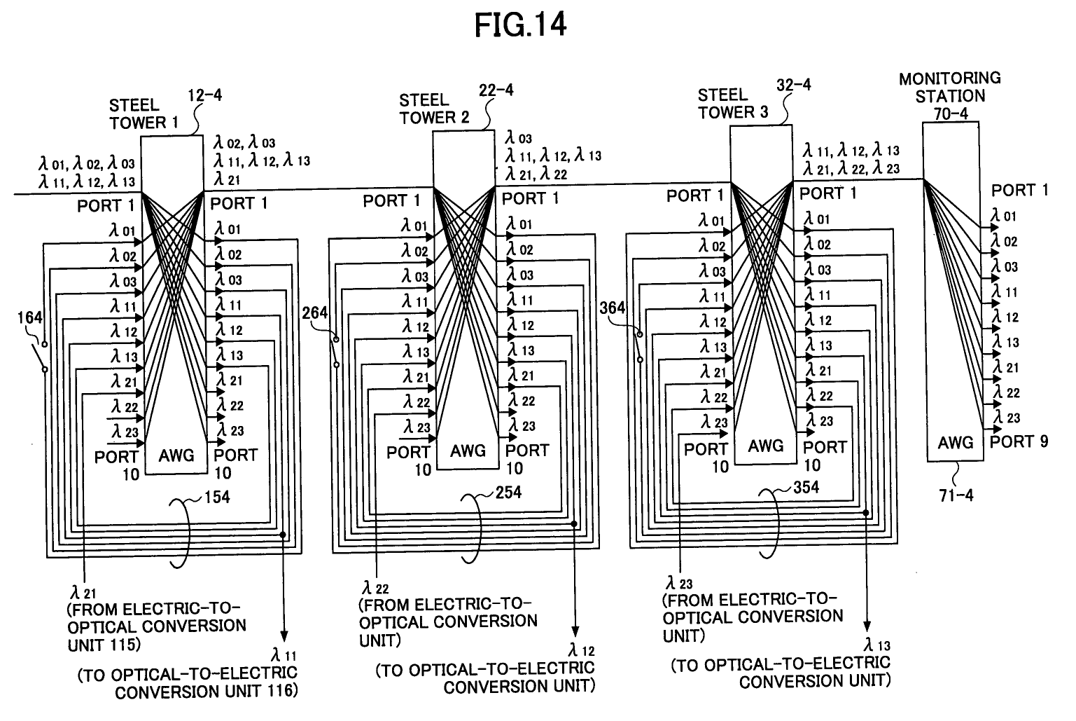

FIG. 14 shows connections of arrayed waveguide gratings according to the fourth embodiment. This drawing illustrates exemplary drop and add operations executed on optical failure detection signals, moving image signals, and control signals by the AWG units 12-4, 22-4, and 32-4 of the steel towers 1, 2, and 3, respectively. It is noted that the illustrated operations correspond to those executed in accordance with the exemplary signal flow shown in FIG. 12.

According to the present example, at the steel tower 1, optical failure detection signals with wavelengths λ₀₁, λ₀₂, and λ₀₃, and control signals with wavelengths λ₁₁, λ₁₂, and λ₁₃ are multiplexed and supplied to an input port 1 of the AWG unit 12-4.

In turn, the AWG unit 12-4 demultiplexes the multiplexed optical signals into wavelength components, and outputs the demultiplexed wavelength components from their corresponding output ports 2 through 7. The wavelength components are then passed through pass connection optical fibers 154 to be supplied to their corresponding input ports 2 though 7.

The control signal with the wavelength λ₁₁ is demultiplexed from the pass connection optical fiber 154 and supplied to the optical-to-electrical conversion unit 116 (see FIG. 9). Also, a moving image signal with wavelength λ₂₁ that is supplied from the electric-to-optical conversion unit 115 is supplied to an input port 8 of the AWG unit 12-4.

According to the present embodiment, an optical switch 164 is connected to the pass connection optical fiber 154 for the wavelength λ₀₁. The optical switch 164 has a function identical to that of the optical switch 162 of the second embodiment (see FIG. 7). Accordingly, the optical failure detection signal with wavelengths λ₀₁ may be optically blocked in response to the detection of a failure in the steel tower 1.

Also, according to the present embodiment, an optical signal that is supplied from an LD 102 (see FIG. 9) may be used as a trigger signal to block the wavelength component 01 that is unique to the steel tower 1 out of the demultiplexed wavelength components supplied to the AWG unit 12-4. It is noted that this trigger signal is not necessarily limited to blocking the unique wavelength component λ₀₁ as is described in relation to the second embodiment.

Consequently, the optical failure detection signals with wavelengths λ₀₂ and λ₀₃, the control signals with wavelengths λ₁₁, λ₁₂, and λ₁₃, and a moving image signal with wavelength λ₂₁ are multiplexed and output from an output port 1 of the AWG unit 12-4 and transmitted to the OPGW optical fiber on the monitoring station 70-4 side.

At the steel tower 2, the multiplexed optical signal from the steel tower 1 is supplied to an input port 1 of the AWG unit 22-4. In turn, the AWG unit 22-4 demultiplexes the supplied optical signal into wavelength components, and outputs the demultiplexed wavelength components from their corresponding output ports 3 through 8. The wavelength components are then passed through pass connection optical fibers 254 to be supplied to their corresponding input ports 3 though 8.

The control signal with the wavelength λ₁₂ is demultiplexed from its corresponding pass connection optical fiber 254 and supplied to the optical-to-electrical conversion unit (not shown) of the steel tower 2. Also, a moving image signal with wavelength λ₂₂ that is supplied from the electric-to-optical conversion unit (not shown) of the steel tower 2 is supplied to an input port 9 of the AWG unit 22-4.

According to the present embodiment, an optical switch 264 is connected to the pass connection optical fiber 254 for the wavelength λ₀₂. The optical switch 264 has a function identical to that of the optical switch 164 of the steel tower 1. Accordingly, the optical failure detection signal with wavelengths λ₀₂ may be optically blocked in response to the detection of a failure in the steel tower 2.

Consequently, the optical failure detection signal with wavelength λ₀₃, the control signals with wavelengths λ₁₁, λ₁₂, and λ₁₃, and moving image signals with wavelengths λ₂₁ and λ₂₂ are multiplexed and output from an output port 1 of the AWG unit 22-4 and transmitted to the OPGW optical fiber on the monitoring station 70-4 side.

At the steel tower 3, the multiplexed optical signal from the steel tower 2 is supplied to an input port 1 of the AWG unit 32-4. In turn, the AWG unit 32-4 demultiplexes the supplied optical signal into wavelength components, and outputs the demultiplexed wavelength components from their corresponding output ports 4 through 9. The wavelength components are then passed through pass connection optical fibers 354 to be supplied to their corresponding input ports 4 though 9.

The control signal with the wavelength λ₁₃ is demultiplexed from its corresponding pass connection optical fiber 354 and supplied to the optical-to-electrical conversion unit (not shown) of the steel tower 3. Also, a moving image signal with wavelength λ₂₃ that is supplied from the electric-to-optical conversion unit (not shown) of the steel tower 3 is supplied to an input port 10 of the AWG unit 32-4.

According to the present embodiment, an optical switch 364 is connected to the pass connection optical fiber 354 for the wavelength λ₀₃. The optical switch 364 has a function identical to that of the optical switch 164 of the steel tower 1. Accordingly, the optical failure detection signal with wavelengths λ₀₃ may be optically blocked in response to the detection of a failure in the steel tower 3.

Consequently, the control signals with wavelengths λ₁₁, λ₁₂, and λ₁₃, and moving image signals with wavelengths λ₂₁, λ₂₂, and λ₂₃ are multiplexed and output from an output port 1 of the AWG unit 32-4 and transmitted to the OPGW optical fiber on the monitoring station 70-4 side.

Then, the multiplexed optical signal from the steel tower 3 is received at an input port 1 of the AWG 71-4 of the monitoring station 70-4. The AWG 71-4 demultiplexes the multiplexed optical signal into wavelength components, and outputs these wavelength components from their corresponding output ports 1˜9. In the present example, the optical failure detection signals with wavelengths λ₀₁, λ₀₂, and λ₀₃ are not output from the output ports 1˜3, the control signals with wavelengths λ₁₁, λ₁₂, and λ₁₃ are output from the output ports 4˜6, and the moving image signals with wavelengths λ₂₁, λ₂₂, and λ₂₃ are output from the output ports 7˜9.

It is noted that various changes and modifications may be made to the third and fourth embodiments described above. For example, as can be appreciated from the exemplary system configuration shown in FIG. 8, according to the third and fourth embodiments, a multi-wavelength control signal is transmitted from a monitoring station (not shown) that is provided at the left side of the steel tower.

However, the multi-wavelength control signal may alternatively be transmitted from the control apparatus 77-3 of the monitoring station 70-3 or 70-4. In this case, two predetermined core wires of the OPGW optical fiber may be used, one of the core wires being used to realize transmission of optical failure detection signals and moving image signals, and the other core wire being used to realize transmission of control signals.

In this way, communications between the monitoring station positioned at the left side and the monitoring station 70-3 or 70-4 may be facilitated. Specifically, the operation between steps S110 and S111, and the operation between steps S119 through S121 of FIG. 12 may be executed smoothly.

As can be appreciated from the above descriptions, in the multipoint monitoring systems according to the third and fourth embodiments, a moving image may be transmitted using the AWG unit 12-3 or 12-4, the control unit 113, the storage unit 114, the electric-to-optical conversion unit 115, and the optical-to-electric conversion unit 116.

The control unit 113 instructs the video camera 16 to capture a moving image in response to the occurrence of a failure at the steel tower 1. The storage unit 114 stores the image information captured by the video camera as a memory image. The control unit 113 reads the memory image stored in the storage unit 114 in response to a control signal (memory image transmission request) from the monitoring station, and instructs the electric-to-optical conversion unit 115 to convert the read memory image into an optical signal. The electric-to-optical conversion unit 115 converts the read memory image into an optical signal with a wavelength that is unique to the steel tower 1 and transmits the optically converted signal to the AWG unit 12-3 or 12-4.

The control unit 113 is also arranged to instruct the video camera 16 to capture an online image in response to a control signal (online image transmission request) that is received after the transmission of the memory image. In turn, the electric-to-optical conversion unit 115 converts the online image captured by the video camera 16 into an optical signal with the wavelength that is unique to the steel tower 1, and transmits the converted signal to the AWG unit 12-3 or 12-4.

It is noted that according to the third and fourth embodiments of the present invention, after a memory image is captured and stored in response to the detection of a failure at a steel tower, subsequent operations are executed based on control signals supplied from the monitoring station (not shown) provided at the left side. However, in other embodiments of the present invention, the control unit 113 may be arranged to administer the capturing, storing, and transmission of the memory image, as well as the capturing and transmission of the online image in response to the detection of a failure occurring at a steel tower.

According to embodiments of the present invention, the AWG unit 12-3 or 12-4 is arranged to multiplex a moving image (i.e., memory image or online image), which is captured at the steel tower at which a failure is detected and converted into an optical signal, with an optical signal that is supplied from the OPGW optical fiber and transmitted to the OPGW optical fiber. By realizing moving image transmission in this manner, the monitoring stations 70-3 or 70-4 may be able to make a detailed analysis of the start of a failed steel tower at a remote location before conducting maintenance and restoration operations on the steel tower.

In the following, a multipoint monitoring system according to a fifth embodiment of the present invention is described. According to the fifth embodiment, the concept of a superordinate steel tower and a subordinate steel tower residing within an area administered by the superordinate steel tower is introduced to the monitoring system according to the first embodiment.

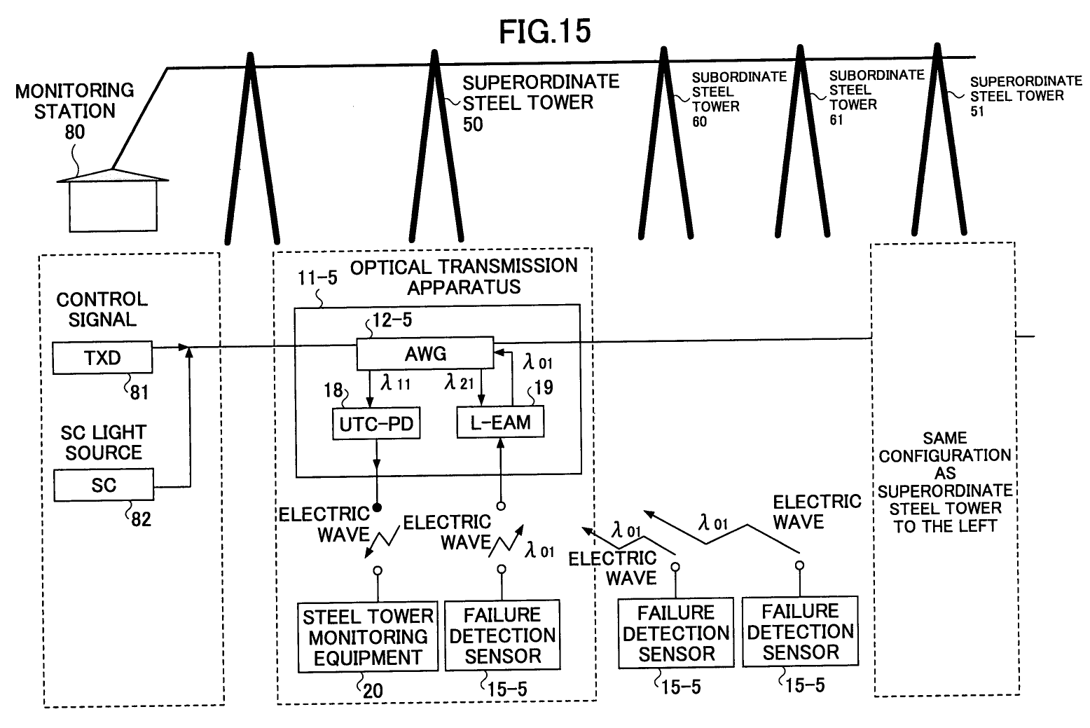

FIG. 15 is a diagram illustrating a configuration of a multipoint monitoring system according to the fifth embodiment. The multipoint monitoring system according to the present embodiment includes a monitoring station 80, superordinate steel towers 50 and 51, and subordinate steel towers 60 and 61. In this example, the superordinate steel towers 50 and 51 are arranged to have functions identical to those provided in the steel towers 1 through n shown in FIG. 1.

The monitoring station 80 includes a control signal generation unit 81 and a super continuum (SC) light source 82. The SC light source 82 generates an optical signal that is made up of plural wavelength components. It is noted that each of the wavelength components of the optical signal is assigned to a particular usage within a given steel tower. For example, at the superordinate steel tower 50, wavelength λ₁₁ is assigned for a control signal, and wavelength λ₂₁ is assigned for a carrier wave signal used in generating an optical failure detection signal.

According to the present embodiment, the control signal corresponds to a signal for controlling monitoring equipment 20, which is accommodated in each of the superordinate steel towers 50, 51, . . . . This control signal is generated at the control signal generation unit 81 and is transmitted via the OPGW optical fiber.

The superordinate steel tower 50 is arranged to detect a failure occurring within its own facilities (i.e. failure occurring at the steel tower 50 itself) as well as failures occurring at subordinate steel towers 60, 61 residing within an administered area of this superordinate steel tower 50. It is noted that in the present example, the configurations of the superordinate steel towers 50 and 51 are identical, so only the configuration of the superordinate steel tower 50 is described below.

As is shown in the drawing, the superordinate steel tower 50 includes a transmission apparatus 11-5 and a failure detection sensor 15-5, and the transmission apparatus 11-5 includes an AWG unit 12-5, a uni-traveling carrier photodiode (UTC-PD) 18, and a lumped electro-absorption modulator (L-EAM) 19.

In the present embodiment, the AWG unit 12-5 is arranged to demultiplex a wavelength component λ₁₁ that is unique to the superordinate steel tower 50 from control signals supplied by the monitoring station 80, and supply the demultiplexed wavelength component to the UTC-PD 18. The AWG unit 12-5 is also arranged to demultiplex a wavelength component λ₂₁ for generating an optical failure detection signal and supply the demultiplexed wavelength component to the L-EAM 19. Also, the AWG unit 12-5 is arranged to receive an optical failure detection signal with wavelength λ₀₁ that is supplied from the L-EAM 19 when a failure is detected.

The UTC-PD 18 is arranged to convert a control signal with wavelength λ₁₁ that is supplied from the AWG unit 12-5 into an electromagnetic wave through optical-to-electric conversion, and control the monitoring equipment 20 provided within the superordinate steel tower 50 using radio waves. The L-EAM 19 is arranged to conduct amplitude modulation on the optical signal with wavelength λ₂₁ supplied from the AWG unit 12-5 using failure detection signals with wavelength λ₀₁, that are supplied from the respective failure detection sensors 15-5 of the superordinate steel tower 50 and the subordinate steel towers 60 and 61.

According to the present embodiment, a wavelength of the envelope of the optical failure detection signal that is generated by the above-described modulation is arranged to correspond to the wavelength of the failure detection signals generated from the respective steel towers. In this way, Radio-on-Fiber (ROF) may be realized so that the failure detection signals that are generated as electric signals at the respective failure detection sensors 15-5 of the steel towers may be directly transmitted to the OPGW optical fiber as optical signals.

It is noted that in the present embodiment, the failure detection sensors 15-5 of the superordinate steel towers 50 and 51, and the failure detection sensors of the subordinate steel towers 60 and 61 are arranged to have the same function of detecting a failure occurring at the corresponding steel tower and generating a failure detection signal in the form of an electromagnetic wave.

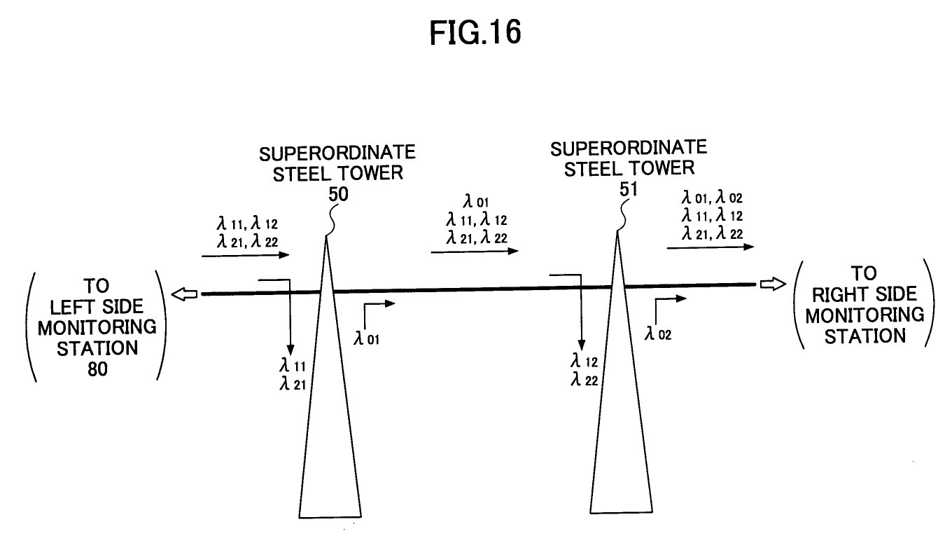

FIG. 16 is a diagram illustrating a signal flow of optical failure detection signals, control signals, and carrier wave signals according to the fifth embodiment. It is noted that the illustrated example corresponds to the example shown in FIG. 4 in relation to the first embodiment; namely, this drawing illustrates a signal flow in the case where optical failure detection signals with wavelengths λ₀₁ and λ₀₂, control signals with wavelengths λ₁₁ and λ₁₂, and carrier wave signals with wavelengths λ₂₁ and λ₂₂ that are transmitted from the superordinate steel towers 50 and 51 are transmitted simultaneously.

According to the present example, control signals with wavelengths λ₁₁ and λ₁₂, and carrier wave signals with wavelengths λ₂₁ and λ₂₂ are multiplexed and input to the superordinate steel tower 50 using the OPGW optical fiber as a transmission line.

If a failure occurs at one of the steel towers residing within the administered area of the superordinate steel tower 50, a carrier wave signal with wavelength λ₂₁ that is unique to the superordinate steel tower 50 is used to generate an optical failure detection signal with wavelength λ₀₁. Also, the control signal with wavelength λ₁₁ is used. In this way, the optical failure detection signal with wavelength λ₀₁, the control signals with wavelengths λ₁₁, and λ₁₂, and the carrier wave signals with wavelengths λ₂₁ and λ₂₂ are multiplexed and transmitted to the OPGW optical fiber directed toward the monitoring station (not shown) positioned at the right hand side.

If a failure occurs at one of the steel towers residing within the administered area of the superordinate steel tower 51, a carrier wave signal with wavelength λ₂₂ that is unique to the superordinate steel tower 51 is used to generate an optical failure detection signal with wavelength λ₀₂. Also, the control signal with wavelength λ₁₂ is used. In this way, the optical failure detection signals with wavelengths λ₀₁ and λ₀₂, the control signals with wavelengths λ₁₁ and λ₁₂, and the carrier wave signals with wavelengths λ₂₁ and λ₂₂ are multiplexed and transmitted to the OPGW optical fiber toward the monitoring station (not shown) positioned at the right side.

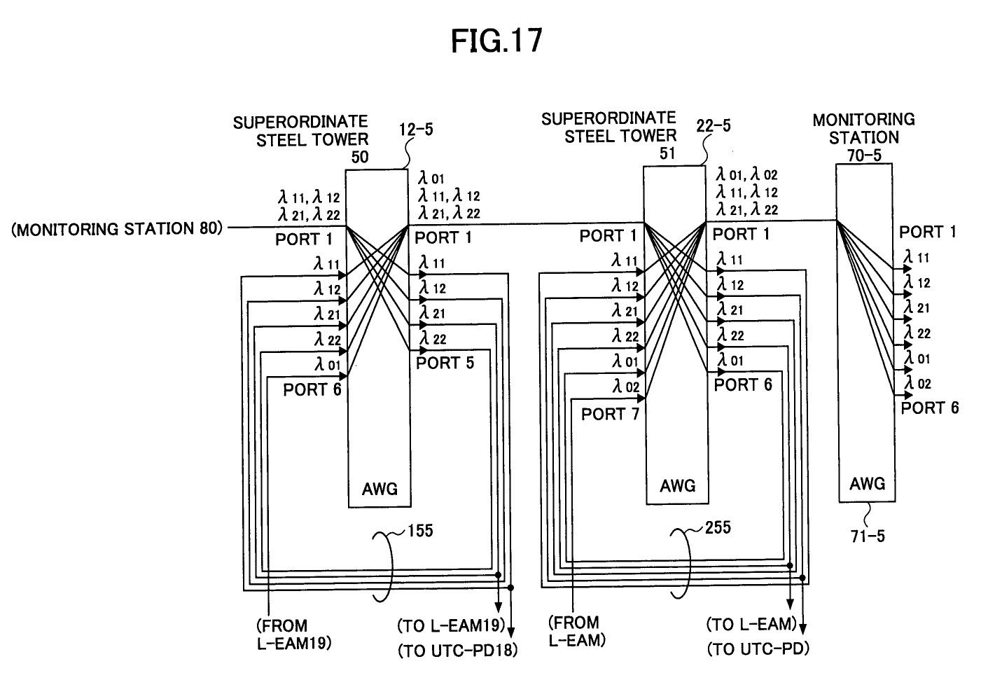

FIG. 17 is a diagram illustrating connections of arrayed waveguide gratings according to the fifth embodiment. It is noted that the illustrated example corresponds to the example shown in FIG. 15; specifically, this drawing illustrates drop and add operations on optical failure detection signals, control signals, and carrier wave signals conducted by AWG units 12-5 and 22-5 of the superordinate steel towers 50 and 51.

According to the present example, at the superordinate steel tower 50, control signals with wavelengths λ₁₁ and λ₁₂, and carrier wave signals with wavelengths λ₂₁ and λ₂₂ are multiplexed and input to an input port 1 of the AWG unit 12-5. In turn, the AWG unit 12-5 demultiplexes the supplied control signals and carrier wave signals into wavelength components and outputs the demultiplexed wavelength components from corresponding output ports 2˜5.

Then, the demultiplexed wavelength components are passed through pass connection optical fibers 155 to be supplied to their corresponding input ports 2˜5. The control signal with wavelength λ₁₁ is demultiplexed from its corresponding pass connection optical fiber 155 to be supplied to the UTC-PD 18.

Also, the carrier wave signal with wavelength λ₂₁ is demultiplexed from its corresponding pass connection optical fiber 155 and supplied to the L-EAM 19. In turn, an optical failure detection signal with wavelength λ₀₁ is generated at the L-EAM 19 and supplied to an input port 6 of the AWG unit 12-5.

In this way, the optical failure detection signal with wavelength λ₀₁, the control signals with wavelengths λ₁₁ and λ₁₂, and the carrier wave signals with wavelengths λ₂₁ and λ₂₂ are multiplexed and output from an output port 1 of the AWG unit 12-5, to be transmitted to the OPGW optical fiber toward the monitoring station 70-5 positioned at the right side.

The multiplexed optical signal from the superordinate steel tower 50 is then supplied to an input port 1 of the AWG unit 22-5 of the superordinate steel tower 51. In turn, the AWG unit 22-5 demultiplexes the supplied optical failure detection signal, control signals and carrier wave signals into wavelength components and outputs the demultiplexed wavelength components from corresponding output ports 2˜6.

Then, the demultiplexed wavelength components are passed through pass connection optical fibers 255 to be supplied to their corresponding input ports 2˜6. The control signal with wavelength λ₁₂ is demultiplexed from its corresponding pass connection optical fiber 255 to be supplied to a UTC-PD (not shown) of the superordinate steel tower 51.

Also, the carrier wave signal with wavelength λ₂₂ is demultiplexed from its corresponding pass connection optical fiber 255 and supplied to a L-EAM (not shown) of the superordinate steel tower 51. In turn, an optical failure detection signal with wavelength λ₀₂ is generated at this L-EAM and supplied to an input port 7 of the AWG unit 22-5.

In this way, the optical failure detection signals with wavelengths λ₀₁ and λ₀₂, the control signals with wavelengths λ₁₁ and λ₁₂, and the carrier wave signals with wavelengths λ₂₁ and λ₂₂ are multiplexed and output from an output port 1 of the AWG unit 22-5 to be transmitted to the OPGW optical fiber toward the monitoring station 70-5 positioned at the right side.

The multiplexed optical signal from the superordinate steel tower 51 is then supplied to an input port 1 of an AWG 71-5 of the monitoring station 70-5 positioned at the right side. In turn, the AWG 71-5 demultiplexes the multiplexed optical signal into wavelength components, and outputs the demultiplexed wavelength components from their corresponding output ports 1˜6. For example, the control signals with wavelengths λ₁₁ and λ₁₂ may be output from the output ports 1 and 2, respectively; the carrier wave signals with wavelengths λ₂₁ and λ₂₂ may be output from the output ports 3 and 4, respectively; and the optical failure detection signals with wavelengths λ₀₁ and λ₀₂ may be output from the output ports 5 and 6, respectively.

According to the present embodiment, the optical failure detection signals that may be output from the output ports 5 and 6 of the AWG 71-5, for example, are subsequently amplitude-demodulated, and a resulting envelope generated from the demodulation process is used. Specifically, the wavelength of this envelope is measured in order to determine the steel tower at which a failure has been detected out of the steel towers residing within the administered areas of the superordinate steel tower 50 and the superordinate steel tower 51.

According to the present example, the same wavelength λ₀₁ is assigned for the superordinate steel tower 50 and the subordinate steel towers 60 and 61 residing within the administered area of the superordinate steel tower 50. In this way, the monitoring station 70-5 positioned at the right side may determine a failure of a steel tower on a superordinate steel tower basis; namely, on the basis of the administered area of the superordinate steel tower.

In an alternative example, a unique wavelength may be assigned to each of the superordinate steel tower 50 and the subordinate steel towers 60 and 61 residing within the administered area of the superordinate steel tower 50. In this case, the L-EAM 19 may be arranged to modulate the carrier wave signal with wavelength λ₂₁ that is unique to the superordinate steel tower 50 using an electromagnetic wave with a wavelength that is unique to the steel apparatus at which a failure is detected, and supply the modulated signal to the AWG 12-5, for example. In this way, a failure may be determined on the basis of each steel tower.

As can be appreciated from the above descriptions, the multipoint monitoring system according to the fifth embodiment may include a failure detection sensor 15-5, a L-EAM 19, and an AWG unit 12-5, for example. The L-EAM 19 may be arranged to modulate a direct current light having a wavelength that is unique to the superordinate steel tower 50 (wavelength λ₂₁ in the case of FIG. 17) using an electromagnetic wave having a corresponding wavelength for a failure detection sensor 15-5 that has detected a failure. In this way, the L-EAM 19 may be able to transmit wavelength components that are unique to the respective failure detection sensors 15-5 that are arranged to detect failures in their corresponding steel towers.

The AWG unit may be arranged to demultiplex an optical signal supplied from an OPGW optical fiber into wavelength components, multiplex the demultiplexed wavelength components with the wavelength component unique to the steel tower at which a failure is detected, and transmit the multiplexed wavelength components to the OPGW optical fiber.

The UTC-PD 18 may be arranged to directly convert a direct current light having a wavelength that is unique to the superordinate steel tower 50 (wavelength λ₂₁ in the case of FIG. 17) into an electromagnetic wave for controlling monitoring equipment 20 provided within the superordinate steel tower 50. According to the present embodiment, a system that does not require a light source may be realized by using the L-EAM 19 and the UTC-PD 18, for example.

In the following, a multipoint monitoring system according to a sixth embodiment of the present invention is described. It is noted that the sixth embodiment corresponds to a system in which the concept of a superordinate steel tower and a subordinate steel tower is introduced to the second embodiment of the present invention.

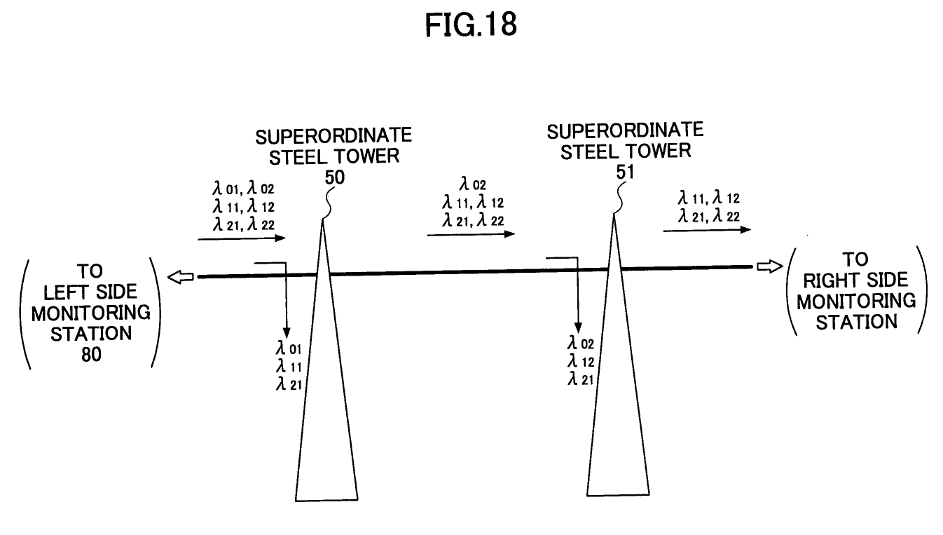

FIG. 18 is a diagram illustrating a signal flow of optical failure detection signals, control signals, and carrier wave signals according to the sixth embodiment. It is noted that the present example corresponds to the example illustrated in FIG. 6 in relation to the second embodiment; namely, this drawing illustrates the signal flow in a case where optical failure detection signals with wavelengths λ₀₁, and λ₀₂, control signals with wavelengths λ₁₁ and λ₁₂, and carrier wave signals with wavelengths λ₂₁ and λ₂₂ that are to be blocked by the superordinate steel towers 50 and 51 are simultaneously transmitted.

According to the present example, when a failure occurs at one of the steel towers included within the administered area of the superordinate steel tower 50, the carrier wave signal with wavelength λ₂₁ is used. This carrier wave signal is modulated by a failure detection signal from a steel tower at which a failure is detected, and in turn, an optical signal having an envelope with wavelength λ₀₁ is generated. In response to the generation of this optical signal, the optical failure detection signal with wavelength λ₀₁ that is to be supplied to the superordinate steel tower 50 is blocked. Also, the control signal with the wavelength λ₁₁ that is unique to the superordinate steel tower 50 is used.

Consequently, the optical failure detection signal with the wavelength λ₀₂, the control signals with wavelengths λ₁₁ and λ₁₂, and the carrier wave signals with wavelengths λ₂₁ and λ₂₂ are multiplexed and transmitted to the OPGW optical fiber that is directed toward a monitoring station 70-6 that is positioned on the right hand side.

If a failure occurs at one of the steel towers included within the administered area of the superordinate steel tower 51, the carrier wave signal with wavelength λ₂₂ is used. This carrier wave signal is modulated by a failure detection signal from the steel tower at which the failure is detected, and in turn, an optical signal having an envelope with wavelength λ₀₂ is generated. In response to the generation of this optical signal, the optical failure detection signal with wavelength λ₀₂ that is to be supplied to the superordinate steel tower 51 is blocked. Also, the control signal with the wavelength λ₁₂ that is unique to the superordinate steel tower 51 is used.

Consequently, the control signals with wavelengths λ₁₁ and λ₁₂, and the carrier wave signals with wavelengths λ₂₁ and λ₂₂ are multiplexed and transmitted to the monitoring station 70-6 that is positioned on the right hand side.

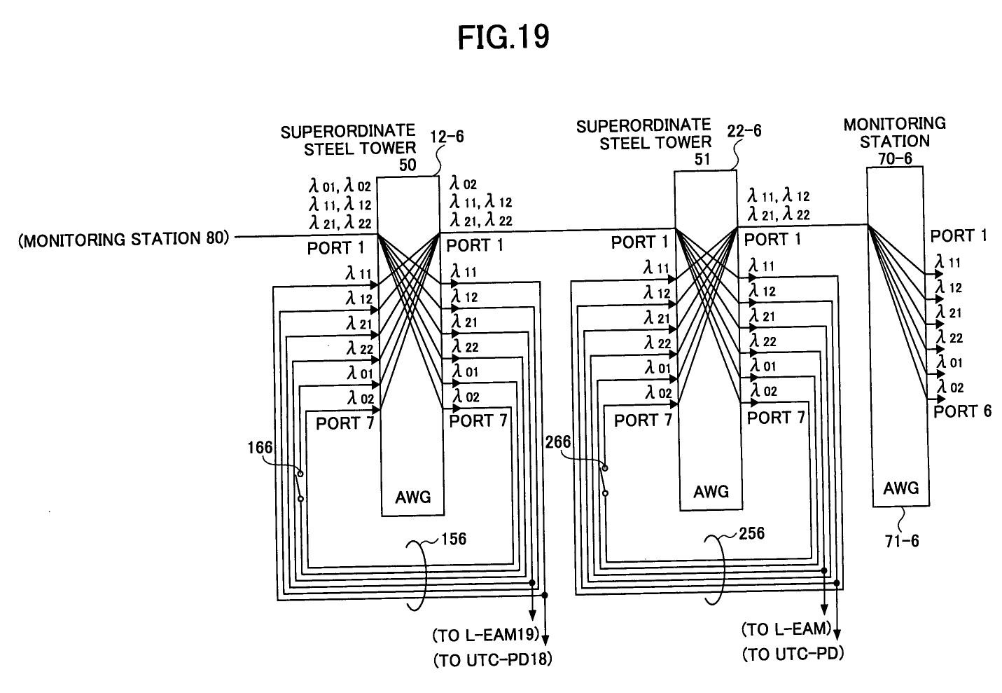

FIG. 19 is a diagram illustrating connections of arrayed waveguide gratings according to the sixth embodiment. It is noted that the present example corresponds to the example shown in FIG. 17 in relation to the fifth embodiment, and illustrates drop and add operations on the optical failure detection signals, control signals, and carrier wave signals that are realized by the AWG units 12-6 and 22-6 of the superordinate steel towers 50 and 51, respectively.

According to this example, at the superordinate steel tower 50, optical failure detection signals with wavelength λ₀₁ and λ₀₂, control signals with wavelengths λ₁₁ and λ₁₂, and carrier wave signals with wavelengths λ₂₁ and λ₂₂ are multiplexed and input to an input port 1 of the AWG unit 12-6.

In turn, the AWG unit 12-6 demultiplexes the supplied optical failure detection signals, control signals and carrier wave signals into wavelength components and outputs the demultiplexed wavelength components from corresponding output ports 2˜7. The demultiplexed wavelength components are then passed through pass connection optical fibers 156 to be supplied to their corresponding input ports 2˜7.

The control signal with wavelength λ₁₁ is demultiplexed from its corresponding pass connection optical fiber 156 to be supplied to the UTC-PD 18 (see FIG. 15). The carrier wave signal with wavelength λ₂₁ is demultiplexed from its corresponding pass connection optical fiber 156 and supplied to the L-EAM 19.

According to the present embodiment, an optical switch 166 is connected to the pass connection optical fiber 156 for the wavelength λ₀₁. The optical switch 166 is normally switched on, and is arranged to be switched off in response to a modulation signal from the L-EAM 19. Accordingly, the optical failure detection signal with wavelengths λ₀₁ may be optically blocked in response to the detection of a failure in at least one of the steel towers included within an administered area of the superordinate steel tower 50.

Also, according to the present embodiment, an optical signal that is supplied from the L-EAM 19 (see FIG. 15) may be used as a trigger signal to block the wavelength component λ₀₁ that is unique to the superordinate steel tower 50 out of the wavelength components demultiplexed by the AWG unit 12-6. However, it is noted that this trigger signal is not necessarily limited to blocking the unique wavelength component λ₀₁ as is described in relation to the present embodiment.

Consequently, the optical failure detection signal with wavelength λ₀₂, the control signals with wavelengths λ₁₁ and λ12, and the carrier wave signals with wavelengths λ₂₁ and λ₂₂ are multiplexed and output from an output port 1 of the AWG unit 12-4 and transmitted to the OPGW optical fiber on the monitoring station 70-6 side.

At the superordinate steel tower 51, the multiplexed optical signal from the steel tower 50 is input to an input port 1 of the AWG unit 22-6. In turn, the AWG unit 22-6 demultiplexes the supplied optical failure detection signal, control signals and carrier wave signals into wavelength components and outputs the demultiplexed wavelength components from corresponding output ports 2˜7. The demultiplexed wavelength components are then passed through pass connection optical fibers 256 to be supplied to their corresponding input ports 2˜7.

The control signal with wavelength λ₁₂ is demultiplexed from its corresponding pass connection optical fiber 256 to be supplied to a UTC-PD 18 (not shown) of the superordinate steel tower 51. The carrier wave signal with wavelength λ₂₂ is demultiplexed from its corresponding pass connection optical fiber 256 and supplied to the L-EAM (not shown) of the superordinate steel tower 51.

According to the present embodiment, an optical switch 266 is connected to the pass connection optical fiber 256 for the wavelength λ₀₂. The optical switch 266 is arranged to have a function identical to that of the optical switch 166. Accordingly, the optical failure detection signal with wavelengths λ₀₂ may be optically blocked in response to the detection of a failure in at least one of the steel towers included within an administered area of the superordinate steel tower 51.

Consequently, the control signals with wavelengths λ₁₁, and λ₁₂, and the carrier wave signals with wavelengths λ₂₁ and λ₂₂ are multiplexed and transmitted to the monitoring station 70-6 positioned on the right hand side.

The multiplexed optical signal from the superordinate steel tower 51 is then supplied to an input port 1 of an AWG 71-6 of the monitoring station 70-6. In turn, the AWG 71-6 demultiplexes the multiplexed optical signal into wavelength components and outputs these wavelength components from their corresponding output ports 1˜6. For example, the control signals with wavelengths λ₁₁ and λ₁₂ may be output from the output ports 1 and 2, respectively; the carrier wave signals with wavelengths λ₂₁ and λ₂₂ may be output from the output ports 3 and 4, respectively; and the optical failure detection signals with wavelengths λ₀₁ and λ₀₂ may be output from the output ports 5 and 6, respectively.

It is noted that in the examples of FIGS. 18 and 19, optical failure detection signals are not output to the output ports 5 and 6. According to the present embodiment, it may be determined that a failure is occurring in at least one of steel towers residing within an administered area for which a corresponding wavelength is not received at the monitoring station.

According to the sixth embodiment, the same wavelength λ₀₁ is assigned for to the superordinate steel tower 50 and the subordinate steel towers 60 and 61 residing within the administered area of the superordinate steel tower 50, as is the case with the fifth embodiment.

In an alternative example, a unique wavelength may be assigned to each of the superordinate steel tower 50 and the subordinate steel towers 60 and 61 residing within the administered area of the superordinate steel tower 50. In this case, the multi-wavelength optical failure detection signal supplied from the monitoring station 80 may include the respective wavelength components that are unique to the superordinate steel tower and subordinate steel towers. Further, at the AWG unit 12-6 of the superordinate steel tower 50, output ports, input ports, pass connection optical fibers, and optical switches corresponding to the respective unique wavelength components for the superordinate steel tower and the subordinate steel towers may be provided, and wavelength identification means (not shown) that is arranged to receive the modulated signal from the L-EAM 19 may be additionally provided.

For example, when a failure occurs at one of either the superordinate steel tower 50, or the subordinate steel tower 60 or 61, the wavelength identification means may be arranged to identify the wavelength of the envelope of a modulated signal supplied from the L-EAM 19 to supply the modulated signal to a corresponding optical switch for the wavelength component unique to the steel tower at which a failure is detected. In this way, the optical failure detection signal for the steel tower at which a failure is detected may be blocked, and thereby the occurrence of a failure may be determined with respect to each steel tower.

As can be appreciated from the above descriptions, the multipoint monitoring system according to the sixth embodiment includes a L-EAM 19, an AWG unit 12-5, and an optical switch 166. The L-EAM 19 is arranged to receive failure detection signals from plural failure detection sensors (see FIG. 15). Also, the L-EAM 19 is arranged to conduct amplitude modulation on a direct current light having a wavelength that is unique to the superordinate steel tower 50 (wavelength λ₂₁ in the case of FIG. 19) using an electromagnetic wave having a wavelength corresponding to that for a failure detection sensor 15-5 that has detected a failure. In this way, the L-EAM 19 may be able to transmit wavelength components that are unique to the respective failure detection sensors 15-5 that are arranged to detect failures in their corresponding steel towers.

The optical switch 166 is arranged to block a wavelength component that is unique to a steel tower at which a failure is detected out of the wavelength components demultiplexed by the AWG unit 12-6 based on the outputs of the corresponding failure detection sensor 15-5 and the L-EAM 19. In turn, the AWG unit 12-6 multiplexes the demultiplexed wavelength components other than that blocked by the optical switch 166 and transmits the resulting signal to the OPGW optical fiber.

The UTC-PD 18 may be arranged to directly convert a direct current light having a wavelength that is unique to at least two steel towers (wavelength λ₂₁ in the case of FIG. 19) into an electromagnetic wave for controlling monitoring equipment sets that are provided in the at least two steel towers.

It is noted that according to other embodiments of the present invention, the features of the fifth/sixth embodiment as is described above may be combined with the features of the third/fourth embodiment. For example, the moving image transmission function described in relation to the third embodiment may be implemented in the multipoint monitoring system according to the fifth embodiment. Similarly, the moving image transmission function that is described in relation to the fourth embodiment may be implemented in the multipoint monitoring system according to the sixth embodiment.

In such cases, a control unit 113, a storage unit 114, an electric-to-optical conversion unit 115, and an optical-to-electric conversion unit 116 illustrated in FIG. 9 may be provided in the optical transmission apparatus 11-5 of FIG. 15, and the process sequence as illustrated in FIG. 12 may be executed by these components.

Also, it is noted that according to an embodiment, the configurations of the optical transmission apparatus 11-5 and the failure detection sensor 15-5 that are illustrated in relation to the fifth embodiment (see FIG. 15) may be implemented in place of the configurations of the optical transmission apparatus 11-1 and the failure detection sensor 15-1 that are illustrated in relation to the first embodiment. Similarly, the configurations of the optical transmission apparatus and the failure detection sensor illustrated in relation to the sixth embodiment may be implemented in place of the configurations of the optical transmission apparatus and the failure detection sensor that are illustrated in relation to the second embodiment. In other words, the first and second embodiments may be modified to realize a system in which a light source (e.g., the light source 101-1 and detection unit 106-1 shown in FIGS. 2 and 9) is not required.

In such cases, the system shown in FIG. 1 may be adapted so that carrier wave signals (first direct current light) with wavelengths that are unique to the respective steel towers may be multiplexed and transmitted to the OPGW optical fiber from the monitoring station (not shown) positioned on the left hand side, for example. In this way, amplitude modulation by the L-EAM 19 (see FIG. 15) that is described in relation to the fifth and sixth embodiments may be realized.

Also, in the systems according to the first through sixth embodiments as described above, the arrangements of the arrayed waveguide gratings are based on a multi-input/multi-output concept (see FIGS. 5, 7, 11, 14, 17, and 19). It is noted that such concept may include arrangements for establishing connection for a corresponding wavelength component by connecting an output of an arrayed waveguide grating used as a one-input/multi-output system to an input of an arrayed waveguide grating used as a multi-input/one-output system with a pass connection optical fiber, for example.

It is noted that a multipoint monitoring system according to an embodiment of the present invention may be applied to various industrial fields including a power transmission line system, a power distribution line system, a road management system, a railroad management system, and a pipeline system, for example. In such industrial fields, an embodiment of the present invention may be applied to an existing optical fiber transmission system. According to an embodiment, an available core wire of an optical fiber within an existing optical fiber transmission system may be used.

Also, a multipoint monitoring system according to an embodiment of the present invention may be applied to industrial fields such as a building management system and a contract home security monitoring system within an urban area, for example. In such industrial fields, the monitoring system may be applied within a relatively small range, and thereby, an optical fiber transmission system may be newly constructed. By implementing an embodiment of the present invention in these application fields, an electrical and/or mechanical abnormality of a facility/equipment may be detected, for example.

It is noted that the failure detection sensors 15-1, 15-3, and 15-5 described above may correspond to abnormality detection units according to embodiments of the present invention. The light source unit 101-1 and the detection unit 106-1, and the L-EAM 19 may correspond to optical transmission units according to embodiments of the present invention. The AWG units 12-1, 12-2, 12-3, 12-4, 12-5, and 12-6 may correspond to arrayed waveguide gratings according to embodiments of the present invention. The optical switches 162, 164, and 166 may correspond to switch units according to embodiments of the present invention. The video camera 16 may correspond to an image capturing unit according to an embodiment of the present invention. The electric-to-optical conversion unit 115 and the AWG units 12-3 and 12-4 may correspond to moving image output units according to embodiments of the present invention.

Further, it is noted that the present invention is not limited to the specific embodiments described above, and variations and modifications may be made without departing from the scope of the present invention.

1. A multipoint monitoring method for monitoring a plurality of monitoring points which monitoring points are connected to a monitoring station by an optical transmission line, the method comprising the steps of:
multiplexing onto an optical signal supplied from the optical transmission line an optical abnormality detection signal having a wavelength component that is unique to a corresponding monitoring point at which abnormality is detected of the monitoring points, and outputting the multiplexed optical signal to the optical transmission line; and
demultiplexing the multiplexed optical signal supplied to the monitoring station from the optical transmission line into wavelength components, and determining the corresponding monitoring point at which the abnormality is detected.

2. The multipoint monitoring method as claimed in claim 1, further comprising the steps of:
converting a moving image captured at the corresponding monitoring point into an optical moving image signal, multiplexing the optical moving image signal onto the optical signal supplied from the optical transmission line, and outputting the multiplexed optical signal to the optical transmission line.

3. A multipoint monitoring method for monitoring a plurality of monitoring points which monitoring points are connected to a monitoring station by an optical transmission line, the method comprising the steps of:
receiving from the optical transmission line a multiplexed optical signal containing wavelength components that are unique to the respective monitoring points, and demultiplexing the multiplexed optical signal into the wavelength components;
blocking a specific wavelength component of the demultiplexed wavelength components, the specific wavelength component being unique to a corresponding monitoring point at which abnormality is detected of the monitoring points;
multiplexing the demultiplexed wavelength components other than the blocked wavelength component and outputting the multiplexed wavelength components to the optical transmission line; and
demultiplexing the multiplexed wavelength components supplied to the monitoring station from the optical transmission line into the wavelength components other than the blocked wavelength component and determining the corresponding monitoring point at which the abnormality is detected.

4. The multipoint monitoring system as claimed in claim 3, further comprising the steps of:
converting a moving image captured at the corresponding monitoring point into an optical moving image signal, multiplexing the optical moving image signal onto the optical signal supplied from the optical transmission line, and outputting the multiplexed optical signal to the optical transmission line.

5. A monitoring point apparatus that is used to realize a multipoint monitoring method for monitoring a plurality of monitoring points which monitoring points are connected to a monitoring station by an optical transmission line, the apparatus comprising:
an abnormality detection unit configured to detect an abnormality of a corresponding monitoring point of the monitoring points;
an optical transmission unit configured to transmit a wavelength component that is unique to the corresponding monitoring point at which the abnormality is detected by the abnormality detection unit; and
an arrayed waveguide grating configured to multiplex the wavelength component that is unique to the corresponding monitoring point onto a wavelength component of an optical signal supplied from the optical transmission line, and output the multiplexed wavelength components to the optical transmission line.

6. The monitoring point apparatus as claimed in claim 5, wherein the optical transmission unit is configured to receive an abnormality detection signal from at least one of plural of the abnormality detection units, conduct amplitude modulation on the wavelength component that is unique to the corresponding monitoring point using a wavelength component assigned to the at least one of the abnormality detection units at which the abnormality is detected, and transmit the modulated wavelength component that is unique to the at least one of the abnormality detection units.

7. The monitoring point apparatus as claimed in claim 5, further comprising:
an image capturing unit configured to capture a moving image of the corresponding monitoring point at which abnormality is detected; and
a moving image output unit configured to convert the moving image captured by the image capturing unit into an optical moving image signal, supply the optical moving image signal to the arrayed waveguide grating, multiplex the optical moving image signal onto the optical signal supplied from the optical transmission line, and output the multiplexed optical signal to the optical transmission line.

8. The monitoring point apparatus as claimed in claim 7, wherein the optical moving image signal has a wavelength that is unique to the corresponding monitoring point at which the abnormality is detected.

9. A monitoring point apparatus that is used to realize a multipoint monitoring method for monitoring a plurality of monitoring points which monitoring points are connected to a monitoring station by an optical transmission line, the apparatus comprising:
an abnormality detection unit configured to detect an abnormality of a corresponding monitoring point;
an optical transmission unit configured to transmit a wavelength component that is unique to the corresponding monitoring point at which the abnormality is detected by the abnormality detection unit;
a first arrayed waveguide grating configured to receive from the optical transmission line a multiplexed optical signal containing wavelength components that are unique to the respective monitoring points, and demultiplex the multiplexed optical signal into the wavelength components;
a switch unit configured to block a specific wavelength component of the wavelength components demultiplexed by the first arrayed waveguide grating according to an output of the abnormality detection unit, the specific wavelength component being unique to the corresponding monitoring point at which the abnormality is detected; and
a second arrayed waveguide grating configured to multiplex the wavelength components demultiplexed by the first arrayed waveguide grating other than the wavelength component blocked by the switch unit, and transmit the multiplexed wavelength components to the optical transmission line.

10. The monitoring point apparatus as claimed in claim 9, wherein the optical transmission unit is configured to receive an abnormality detection signal from at least one of plural of the abnormality detection units, conduct amplitude modulation on the wavelength component that is unique to the corresponding monitoring point using a wavelength component assigned to the at least one of the abnormality detection units at which the abnormality is detected, and transmit the modulated wavelength component that is unique to the at least one of the abnormality detection units at which the abnormality is detected.

11. The monitoring point apparatus as claimed in claim 9, further comprising:
an image capturing unit configured to capture a moving image of the corresponding monitoring point at which abnormality is detected; and
a moving image output unit configured to convert the moving image captured by the image capturing unit into an optical moving image signal, supply the optical moving image signal to the second arrayed waveguide grating, multiplex the optical moving image signal onto the optical signal supplied from the optical transmission line, and output the multiplexed optical signal to the optical transmission line.

12. The monitoring point apparatus as claimed in claim 11, wherein the optical moving image signal has a wavelength that is unique to the corresponding monitoring point at which the abnormality is detected.

13. A monitoring station apparatus that is used to realize a multipoint monitoring method for monitoring a plurality of monitoring points which monitoring points are connected to a monitoring station by an optical transmission line, the apparatus comprising:
an arrayed waveguide grating configured to demultiplex an optical abnormality detection signal supplied from the optical transmission line into wavelength components; and
a reporting unit for reporting an occurrence of an abnormality at a specific monitoring point of the monitoring points based on whether a corresponding wavelength component is supplied from the arrayed waveguide grating.
